(19) United States
(12) Patent Application Publication
(10) Pub. No.: US 2014/0211000 A1
(43) Pub. Date: Jul. 31, 2014

(54) Sensing Signals with Affine-Harmonically Related Rows of Kronecker-Product Matrices

(71) Applicant: InView Technology Corporation, Austin, TX (US)

(72) Inventor: Matthew A. Herman, Austin, TX (US)

(73) Assignee: InView Technology Corporation, Austin, TX (US)

(21) Appl. No.: 14/168,473

(22) Filed: Jan. 30, 2014

Related U.S. Application Data
(60) Provisional application No. 61/759,003, filed on Jan. 31, 2013.

(51) Int. Cl. G01C 11/02

(52) U.S. Cl. CPC G01C 11/025
USPC 348/136

(57) ABSTRACT

A mechanism for efficiently loading rows of an N×N transform matrix H_{N} into a signal-modulating array. A row index m(i) that identifies a row r[m(i)] of H_{N} is generated, where i is in the range {0, 1, . . . , L−1}; L is less than or equal to B; and m(i) is in the range {0, 1, . . . , B−1}. H_{N} has the form H_{N}=H_{F} [symbol] H_{B}. H_{F} is an F×F matrix, and H_{B} is a B×B matrix. [symbol] denotes the Kronecker product. The row r[m(i)] of H_{N} is generated and loaded into the array. For each k in the range {1, 2, . . . , F−1}, a row r[m(i)+kB] from H_{N} is partially loaded into the array by: loading a first subset of elements of row r[m(i)+kB] that are not currently present in the array, and not loading a second subset of elements of row r[m(i)+kB] that are currently present in the array.

### PRIORITY CLAIM DATA

This application claims the benefit of priority to U.S. Provisional Application No. 61/759,003, filed on Jan. 31, 2013, entitled “Harmonically Related Rows of Kronecker-Product Matrices”, invented by Matthew A. Herman, which is hereby incorporated by reference in its entirety as though fully and completely set forth herein.

### FIELD OF THE INVENTION

The present invention relates to the field of compressive sensing, and more particularly, to a mechanism for efficiently generating and loading modulation patterns into a signal modulation array for inner-product based measurements of a signal such as an image.

### DESCRIPTION OF THE RELATED ART

According to Nyquist theory, a signal x(t) whose signal energy is supported on the frequency interval [−B,B] may be reconstructed from samples {x(nT)} of the signal x(t), provided the rate f_{S}=1/T_{S} at which the samples are captured is sufficiently high, i.e., provided that f_{S} is greater than 2B. Similarly, for a signal whose signal energy is supported on the frequency interval [A,B], the signal may be reconstructed from samples captured with sample rate greater than B−A. A fundamental problem with any attempt to capture a signal x(t) according to Nyquist theory is the large number of samples that are generated, especially when B (or B−A) is large. The large number of samples is taxing on memory resources and on the capacity of transmission channels.

Nyquist theory is not limited to functions of time. Indeed, Nyquist theory applies more generally to any function of one or more real variables. For example, Nyquist theory applies to functions of two spatial variables such as images, to functions of time and two spatial variables such as video, and to the functions used in multispectral imaging, hyperspectral imaging, medical imaging and a wide variety of other applications. In the case of an image I(x,y) that depends on spatial variables x and y, the image may be reconstructed from samples of the image, provided the samples are captured with sufficiently high spatial density. For example, given samples {I(nΔx,mΔy)} captured along a rectangular grid, the horizontal and vertical densities 1/Δx and 1/Δy should be respectively greater than 2Bₓ and 2B_{y}, where Bₓ and B_{y} are the highest x and y spatial frequencies occurring in the image I(x,y). The same problem of overwhelming data volume is experienced when attempting to capture an image according to Nyquist theory. The modern theory of compressive sensing is directed to such problems.

Compressive sensing relies on the observation that many signals (e.g., images or video sequences) of practical interest are not only band-limited but also sparse or approximately sparse when represented using an appropriate choice of transformation, for example, a transformation such as a Fourier transform, a wavelet transform or a discrete cosine transform (DCT). A signal vector v is said to be K-sparse with respect to a given transformation T when the transformation of the signal vector, Tv, has no more than K non-zero coefficients. A signal vector v is said to be sparse with respect to a given transformation T when it is K-sparse with respect to that transformation for some integer K much smaller than the number L of components in the transformation vector Tv.

A signal vector v is said to be approximately K-sparse with respect to a given transformation T when the coefficients of the transformation vector, Tv, are dominated by the K largest coefficients (i.e., largest in the sense of magnitude or absolute value). In other words, if the K largest coefficients account for a high percentage of the energy in the entire set of coefficients, then the signal vector v is approximately K-sparse with respect to transformation T. A signal vector v is said to be approximately sparse with respect to a given transformation T when it is approximately K-sparse with respect to the transformation T for some integer K much less than the number L of components in the transformation vector Tv.

Given a sensing device that captures images with N samples per image and in conformity to the Nyquist condition on spatial rates, it is often the case that there exists some transformation and some integer K very much smaller than N such that the transform of each captured image will be approximately K sparse. The set of K dominant coefficients may vary from one image to the next. Furthermore, the value of K and the selection of the transformation may vary from one context (e.g., imaging application) to the next. Examples of typical transforms that might work in different contexts include the Fourier transform, the wavelet transform, the DCT, the Gabor transform, etc.

Compressive sensing specifies a way of operating on the N samples of an image so as to generate a much smaller set of samples from which the N samples may be reconstructed, given knowledge of the transform under which the image is sparse (or approximately sparse). In particular, compressive sensing invites one to think of the N samples as a vector v in an N-dimensional space and to imagine projecting the vector v onto each vector in a series of M vectors {R(i): i=1, 2, . . . , M} in the N-dimensional space, where M is larger than K but still much smaller than N. Each projection gives a corresponding real number S(i), e.g., according to the expression

S(i)=<v,R(i)>,

where the notation <v,R(i)> represents the inner product (or dot product) of the vector v and the vector R(i). Thus, the series of M projections gives a vector U including M real numbers: Uᵢ=S(i). Compressive sensing theory further prescribes methods for reconstructing (or estimating) the vector v of N samples from the vector U of M real numbers and the series of measurement vectors {R(i): i=1, 2, . . . , M}. For example, according to one method, one should determine the vector x that has the smallest length (in the sense of the L₁ norm) subject to the condition that ΦTx=U, where Φ is a matrix whose rows are the transposes of the vectors R(i), where T is the transformation under which the image is K sparse or approximately K sparse.

Compressive sensing is important because, among other reasons, it allows reconstruction of an image based on M measurements instead of the much larger number of measurements N recommended by Nyquist theory. Thus, for example, a compressive sensing camera would be able to capture a significantly larger number of images for a given size of image store, and/or, transmit a significantly larger number of images per unit time through a communication channel of given capacity.

As mentioned above, compressive sensing operates by projecting the image vector v onto a series of M vectors. As discussed in U.S. Pat. No. 8,199,244, issued Jun. 12, 2012 (invented by Baraniuk et al.) and illustrated in FIG. 1, an imaging device (e.g., camera) may be configured to take advantage of the compressive-sensing paradigm by using a digital micromirror device (DMD) 40. An incident lightfield 10 passes through a lens 20 and then interacts with the DMD 40. The DMD includes a two-dimensional array of micromirrors, each of which is configured to independently and controllably switch between two orientation states. Each micromirror reflects a corresponding portion of the incident light field based on its instantaneous orientation. Any micromirrors in a first of the two orientation states will reflect their corresponding light portions so that they pass through lens 50. Any micromirrors in a second of the two orientation states will reflect their corresponding light portions away from lens 50. Lens 50 serves to concentrate the light portions from micromirrors in the first orientation state onto a photodiode (or photodetector) situated at location 60. Thus, the photodiode generates a signal whose amplitude at any given time represents a sum of the intensities of the light portions from the micromirrors in the first orientation state.

The compressive sensing is implemented by driving the orientations of the micromirrors through a series of spatial patterns. Each spatial pattern specifies an orientation state for each of the micromirrors. The output signal of the photodiode is digitized by an A/D converter 70. In this fashion, the imaging device is able to capture a series of measurements {S(i)} that represent inner products (dot products) between the incident light field and the series of spatial patterns without first acquiring the incident light field as a pixelized digital image. The incident light field corresponds to the vector v of the discussion above, and the spatial patterns correspond to the vectors R(i) of the discussion above.

The incident light field may be modeled by a function I(x,y,t) of two spatial variables and time. Assuming for the sake of discussion that the DMD comprises a rectangular array, the DMD implements a spatial modulation of the incident light field so that the light field leaving the DMD in the direction of the lens 50 might be modeled by

{I(nΔx,mΔy,t)*M(n,m,t)}

where m and n are integer indices, where I(nΔx,mΔy,t) represents the portion of the light field that is incident upon that (n,m)^{th} mirror of the DMD at time t. The function M(n,m,t) represents the orientation of the (n,m)^{th} mirror of the DMD at time t. At sampling times, the function M(n,m,t) equals one or zero, depending on the state of the digital control signal that controls the (n,m)^{th} mirror. The condition M(n,m,t)=1 corresponds to the orientation state that reflects onto the path that leads to the lens 50. The condition M(n,m,t)=0 corresponds to the orientation state that reflects away from the lens 50.

The lens 50 concentrates the spatially-modulated light field

{I(nΔx,mΔy,t)*M(n,m,t)}

onto a light sensitive surface of the photodiode. Thus, the lens and the photodiode together implement a spatial summation of the light portions in the spatially-modulated light field:

$$S ( t ) = {\sum }_{n , m} I ( n Δ x , m Δ y , t ) M ( n , m , t ) .$$

Signal S(t) may be interpreted as the intensity at time t of the concentrated spot of light impinging upon the light sensing surface of the photodiode. The A/D converter captures measurements of S(t). In this fashion, the compressive sensing camera optically computes an inner product of the incident light field with each spatial pattern imposed on the mirrors. The multiplication portion of the inner product is implemented by the mirrors of the DMD. The summation portion of the inner product is implemented by the concentrating action of the lens and also the integrating action of the photodiode.

The above-described imaging device involves loading each spatial pattern of a sequence of spatial patterns into the DMD. The data bus connecting the DMD to a device that generates the spatial patterns may be constrained to transfer data serially. Thus, the transfer bandwidth of the data bus imposes a limit on the rate at which spatial patterns can be loaded, and the rate at which images can be compressively acquired by the imaging device. Therefore, there exists a need for improved mechanisms of supplying spatial patterns to light modulating devices (and signal modulating devices) in order to decrease the average pattern load time.

### SUMMARY

In one set of embodiments, a signal measurement system may perform the following operations to facilitate the acquisition of measurements of a signal.

A temporal sequence of measurement patterns is applied to the signal using an array of signal modulating elements, in order to obtain a modulated signal. The application of the temporal sequence of measurement patterns may include partially loading a given one of the measurement patterns into the signal modulating array. The action of partially loading the given measurement pattern includes: (a) loading particular portions of the given measurement pattern that differ from respective portions of a previous one of the measurement patterns, and (b) not loading other portions of the given measurement pattern that agree with respective other portions of the previous measurement pattern. The given measurement pattern may be a pattern that immediately follows the previous measurement pattern in the temporal sequence. A sensing device may be used to obtain measurements of intensity of the modulated signal. Each of the measurements corresponds to a respective one of the measurement patterns of the temporal sequence.

In another set of embodiments, a method for efficiently generating and loading selected rows of an N×N transform matrix H_{N} may be performed as follows.

A row index m(i) is generated, where the row index m(i) identifies a row r[m(i)] of an N×N transform matrix, where i is in the range {0, 1, . . . , L−1}, where L is less than or equal to B, where m(i) is in the range {0, 1, . . . , B−1}. The N×N transform matrix has the form

H_{N}=H_{F} [symbol] H_{B},

where integers F and B are each greater than one, where H_{F} is an F×F matrix, where H_{B} is a B×B matrix, where [symbol] denotes the Kronecker product. It follows that N=B*F.

The row r[m(i)] of the N×N transform matrix is generated and loaded into an array of signal modulating elements such as a digital micromirror device (DMD).

For each k in the range {1, 2, . . . , F−1}, a row r[m(i)+kB] from the N×N transform matrix is partially loaded into the array by: loading a first subset of elements of the row r[m(i)+kB] that are not currently present in said array, and not loading a second subset of elements of the row r[m(i)+kB] that are currently present in said array.

The rows r[m(i)], r[m(i)+B], r[m(i)+2B], r[m(i)+(F−1)B] may be referred to as being “affine-harmonically related”. The term “harmonic” is meant to suggest the multiples of B, and the term “affine” is meant to suggest the addition of m(i) when indexing the rows of matrix H_{N}.

Additional embodiments are described in U.S. Provisional Application No. 61/759,003, filed on Jan. 31, 2013, entitled “Harmonically Related Rows of Kronecker-Product Matrices”, invented by Matthew A. Herman.

### BRIEF DESCRIPTION OF THE DRAWINGS

A better understanding of the present invention can be obtained when the following detailed description of the preferred embodiments is considered in conjunction with the following drawings.

FIG. 1 illustrates a compressive sensing camera according to the prior art.

FIG. 2A illustrates one embodiment of a system 100 that is operable to capture compressive imaging samples and also samples of background light level. (LMU is an acronym for “light modulation unit”. MLS is an acronym for “modulated light stream”. LSD is an acronym for “light sensing device”.)

FIG. 2B illustrates an embodiment of system 100 that includes a processing unit 150.

FIG. 2C illustrates an embodiment of system 100 that includes an optical subsystem 105 to focus received light L onto the light modulation unit 110.

FIG. 2D illustrates an embodiment of system 100 that includes an optical subsystem 117 to direct or focus or concentrate the modulated light stream MLS onto the light sensing device 130.

FIG. 2E illustrates an embodiment where the optical subsystem 117 is realized by a lens 117L.

FIG. 2F illustrates an embodiment of system 100 that includes a control unit that is configured to supply a series of spatial patterns to the light modulation unit 110.

FIG. 3A illustrates system 200, where the light modulation unit 110 is realized by a plurality of mirrors (collectively referenced by label 110M).

FIG. 3B shows an embodiment of system 200 that includes the processing unit 150.

FIG. 4 shows an embodiment of system 200 that includes the optical subsystem 117 to direct or focus or concentrate the modulated light stream MLS onto the light sensing device 130.

FIG. 5A shows an embodiment of system 200 where the optical subsystem 117 is realized by the lens 117L.

FIG. 5B shows an embodiment of system 200 where the optical subsystem 117 is realized by a mirror 117M and lens 117L in series.

FIG. 5C shows another embodiment of system 200 that includes a TIR prism pair 107.

FIG. 6 shows an XGA-format 768×1024 DMD (digital micromirror device) divided into 16 DMD-blocks, each with 48×1024 mirrors.

FIG. 7 illustrates the structure of a matrix H_{N} where H_{N} is a Kronecker product between a Hadamard matrix H_{F} and a matrix H_{B}.

FIG. 8 illustrates one embodiment of a method 800 for efficiently loading rows of a measurement matrix into a signal modulating array.

FIG. 9 illustrates one embodiment of a method 900 for facilitating the acquisition of measurements of a signal using an array of signal modulating elements.

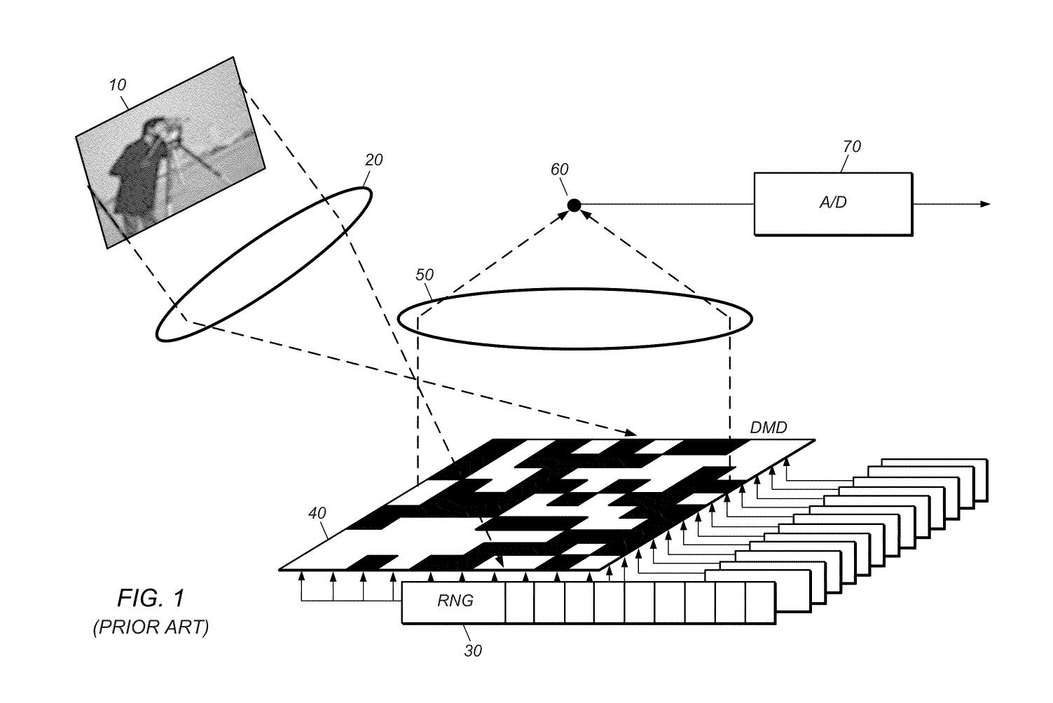

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

### Incorporations by Reference

The following documents are hereby incorporated by reference in their entireties as though fully and completely set forth herein.

U.S. patent application Ser. No. 13/207,900, filed Aug. 11, 2011, entitled “TIR Prism to Separate Incident Light and Modulated Light in Compressive Imaging Device”, invented by McMackin and Chatterjee;

U.S. patent application Ser. No. 13/197,304, filed Aug. 3, 2011, entitled “Decreasing Image Acquisition Time for Compressive Imaging Devices”, invented by Kelly, Baraniuk, McMackin, Bridge, Chatterjee and Weston;

U.S. patent application Ser. No. 14/106,542, filed Dec. 13, 2013, entitled “Overlap Patterns and Image Stitching for Multiple-Detector Compressive-Sensing Camera”, invented by Herman, Hewitt, Weston and McMackin.

Terminology

A memory medium is a non-transitory medium configured for the storage and retrieval of information. Examples of memory media include: various kinds of semiconductor-based memory such as RAM and ROM; various kinds of magnetic media such as magnetic disk, tape, strip and film; various kinds of optical media such as CD-ROM and DVD-ROM; various media based on the storage of electrical charge and/or any of a wide variety of other physical quantities; media fabricated using various lithographic techniques; etc. The term “memory medium” includes within its scope of meaning the possibility that a given memory medium might be a union of two or more memory media that reside at different locations, e.g., in different portions of an integrated circuit or on different integrated circuits in an electronic system or on different computers in a computer network.

A computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

A computer system is any device (or combination of devices) having at least one processor that is configured to execute program instructions stored on a memory medium. Examples of computer systems include personal computers (PCs), workstations, laptop computers, tablet computers, mainframe computers, server computers, client computers, network or Internet appliances, hand-held devices, mobile devices, personal digital assistants (PDAs), tablet computers, computer-based television systems, grid computing systems, wearable computers, computers implanted in living organisms, computers embedded in head-mounted displays, computers embedded in sensors forming a distributed network, computers embedded in a camera devices or imaging devices or spectral measurement devices, etc.

A programmable hardware element (PHE) is a hardware device that includes multiple programmable function blocks connected via a system of programmable interconnects. Examples of PHEs include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores).

As used herein, the term “light” is meant to encompass within its scope of meaning any electromagnetic radiation whose spectrum lies within the wavelength range [λ_{L}, ═_{U}], where the wavelength range includes the visible spectrum, the ultra-violet (UV) spectrum, infrared (IR) spectrum and the terahertz (THz) spectrum. Thus, for example, visible radiation, or UV radiation, or IR radiation, or THz radiation, or any combination thereof is “light” as used herein.

In some embodiments, a computer system may be configured to include a processor (or a set of processors) and a memory medium, where the memory medium stores program instructions, where the processor is configured to read and execute the program instructions stored in the memory medium, where the program instructions are executable by the processor to implement a method, e.g., any of the various method embodiments described herein, or, any combination of the method embodiments described herein, or, any subset of any of the method embodiments described herein, or, any combination of such subsets.

System 100 for Operating on Light

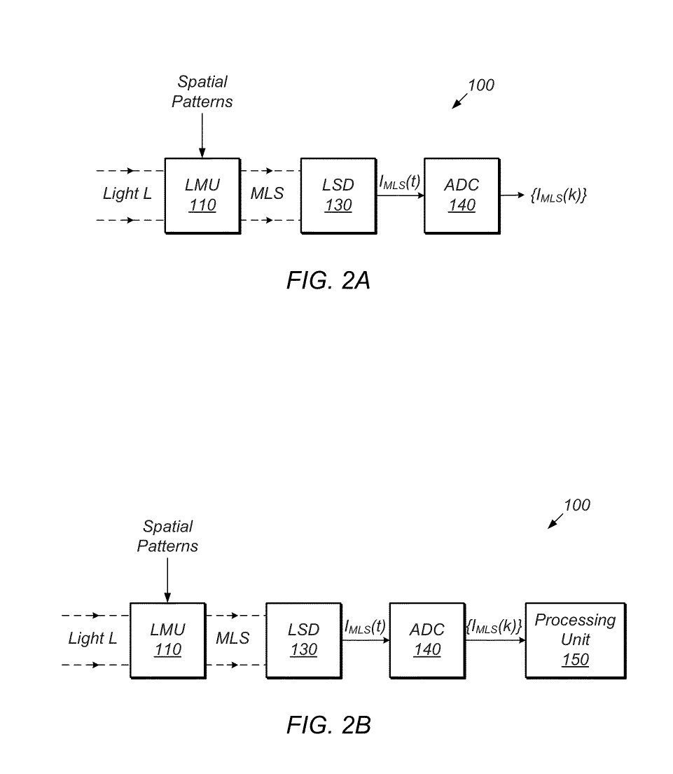

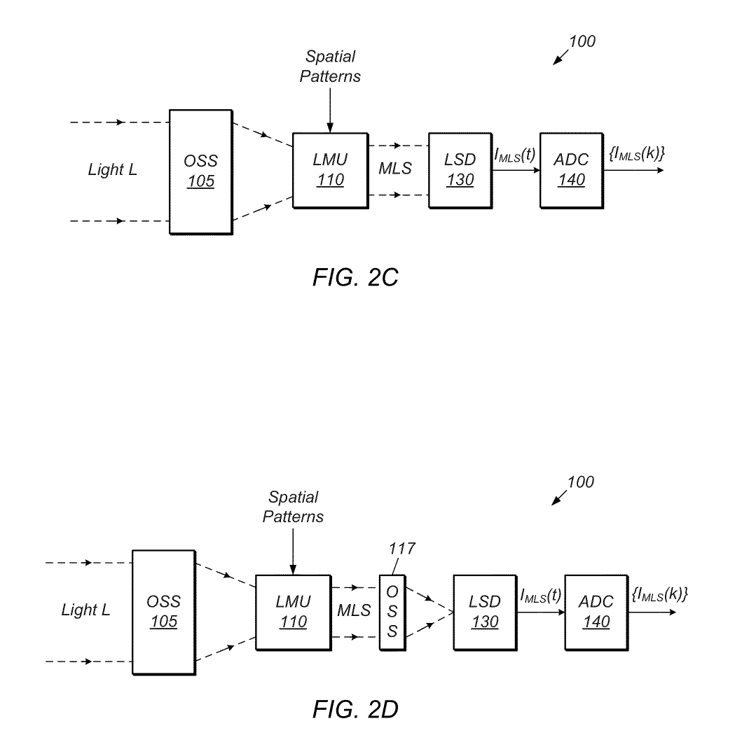

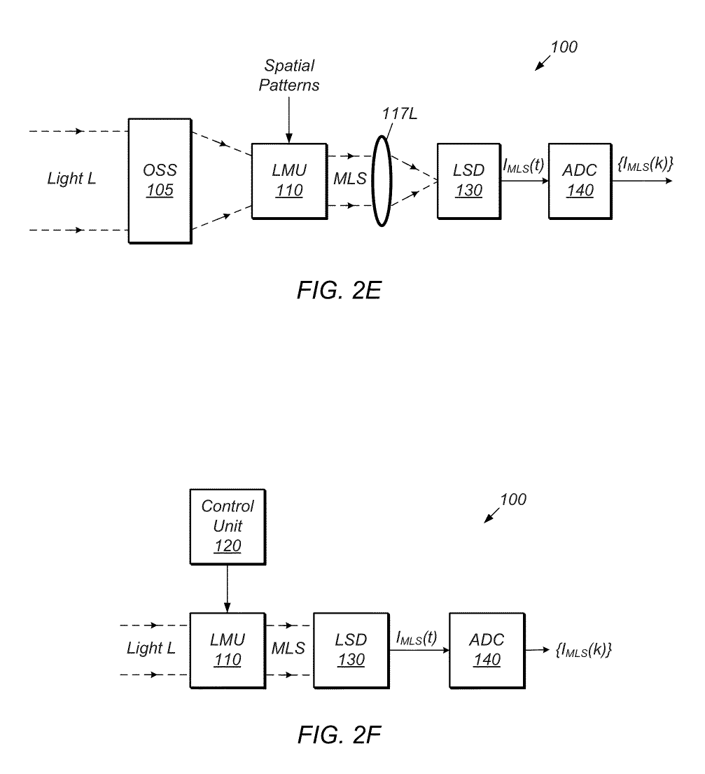

A system 100 for operating on light may be configured as shown in FIG. 2A. The system 100 may include a light modulation unit 110, a light sensing device 130 and an analog-to-digital converter (ADC) 140.

The light modulation unit 110 is configured to modulate a received stream of light L with a series of spatial patterns in order to produce a modulated light stream (MLS). The spatial patterns of the series may be applied sequentially to the light stream so that successive time slices of the light stream are modulated, respectively, with successive ones of the spatial patterns. (The action of sequentially modulating the light stream L with the spatial patterns imposes the structure of time slices on the light stream.) The light modulation unit 110 includes a plurality of light modulating elements configured to modulate corresponding portions of the light stream. Each of the spatial patterns specifies an amount (or extent or value) of modulation for each of the light modulating elements. Mathematically, one might think of the light modulation unit's action of applying a given spatial pattern as performing an element-wise multiplication of a light field vector (xᵢⱼ) representing a time slice of the light stream L by a vector of scalar modulation values (mᵢⱼ), to obtain a time slice of the modulated light stream: (mᵢⱼ)*(xᵢⱼ)=(mᵢⱼ*xᵢⱼ). The vector (mᵢⱼ) is specified by the spatial pattern. Each light modulating element effectively scales (multiplies) the intensity of its corresponding light stream portion by the corresponding scalar factor.

The light modulation unit 110 may be realized in various ways. In some embodiments, the LMU 110 may be realized by a plurality of mirrors (e.g., micromirrors) whose orientations are independently controllable. In another set of embodiments, the LMU 110 may be realized by an array of elements whose transmittances are independently controllable, e.g., as with an array of LCD shutters. An electrical control signal supplied to each element controls the extent to which light is able to transmit through the element. In yet another set of embodiments, the LMU 110 may be realized by an array of independently-controllable mechanical shutters (e.g., micromechanical shutters) that cover an array of apertures, with the shutters opening and closing in response to electrical control signals, thereby controlling the flow of light through the corresponding apertures. In yet another set of embodiments, the LMU 110 may be realized by a perforated mechanical plate, with the entire plate moving in response to electrical control signals, thereby controlling the flow of light through the corresponding perforations. In yet another set of embodiments, the LMU 110 may be realized by an array of transceiver elements, where each element receives and then immediately retransmits light in a controllable fashion. In yet another set of embodiments, the LMU 110 may be realized by a grating light valve (GLV) device. In yet another embodiment, the LMU 110 may be realized by a liquid-crystal-on-silicon (LCOS) device.

In some embodiments, the light modulating elements are arranged in an array, e.g., a two-dimensional array or a one-dimensional array. Any of various array geometries are contemplated. For example, in some embodiments, the array is a square array or rectangular array. In another embodiment, the array is hexagonal. In some embodiments, the light modulating elements are arranged in a spatially random fashion.

Let N denote the number of light modulating elements in the light modulation unit 110. In various embodiments, the number N may take a wide variety of values. For example, in different sets of embodiments, N may be, respectively, in the range [64, 256], in the range [256, 1024], in the range [1024,4096], in the range [2¹²,2¹⁴], in the range [2¹⁴,2¹⁶], in the range [2¹⁶, 2¹⁸], in the range [2¹⁸,2²⁰], in the range [2²⁰,2²²], in the range [2²²,2²⁴], in the range [2²⁴,2²⁶], in the range from 2²⁶ to infinity. The particular value used in any given embodiment may depend on one or more factors specific to the embodiment.

The light sensing device 130 may be configured to receive the modulated light stream MLS and to generate an analog electrical signal I_{MLS}(t) representing intensity of the modulated light stream as a function of time.

The light sensing device 130 may include one or more light sensing elements. The term “light sensing element” may be interpreted as meaning “a transducer between a light signal and an electrical signal”. For example, a photodiode is a light sensing element. In various other embodiments, light sensing elements might include devices such as metal-semiconductor-metal (MSM) photodetectors, phototransistors, phototubes and photomultiplier tubes.

In some embodiments, the light sensing device 130 includes one or more amplifiers (e.g., transimpedance amplifiers) to amplify the analog electrical signals generated by the one or more light sensing elements.

The ADC 140 acquires a sequence of samples {I_{MLS}(k)} of the analog electrical signal I_{MLS}(t). Each of the samples may be interpreted as an inner product between a corresponding time slice of the light stream L and a corresponding one of the spatial patterns. The set of samples {I_{MLS}(k)} comprises an encoded representation, e.g., a compressed representation, of an image (or a video sequence) and may be used to reconstruct the image (or video sequence) based on any reconstruction algorithm known in the field of compressive sensing. (For video sequence reconstruction, the samples may be partitioned into contiguous subsets, and then the subsets may be processed to reconstruct corresponding images.)

In some embodiments, the samples {I_{MLS}(k)} may be used for some purpose other than, or in addition to, image (or video) reconstruction. For example, system 100 (or some other system) may operate on the samples to perform an inference task, such as detecting the presence of a signal or object, identifying a signal or an object, classifying a signal or an object, estimating one or more parameters relating to a signal or an object, tracking a signal or an object, etc. In some embodiments, an object under observation by system 100 may be identified or classified by virtue of its sample set {I_{MLS}(k)} (or parameters derived from that sample set) being similar to one of a collection of stored sample sets (or parameter sets).

In some embodiments, the light sensing device 130 includes exactly one light sensing element. (For example, the single light sensing element may be a photodiode.) The light sensing element may couple to an amplifier (e.g., a TIA) (e.g., a multi-stage amplifier).

In some embodiments, the light sensing device 130 may include a plurality of light sensing elements (e.g., photodiodes). Each light sensing element may convert light impinging on its light sensing surface into a corresponding analog electrical signal representing intensity of the impinging light as a function of time. In some embodiments, each light sensing element may couple to a corresponding amplifier so that the analog electrical signal produced by the light sensing element can be amplified prior to digitization. System 100 may be configured so that each light sensing element receives, e.g., a corresponding spatial portion (or spectral portion) of the modulated light stream.

In one embodiment, the analog electrical signals produced, respectively, by the light sensing elements may be summed to obtain a sum signal. The sum signal may then be digitized by the ADC 140 to obtain the sequence of samples {I_{MLS}(k)}. In another embodiment, the analog electrical signals may be individually digitized, each with its own ADC, to obtain corresponding sample sequences. The sample sequences may then be added to obtain the sequence {I_{MLS}(k)}. In another embodiment, the analog electrical signals produced by the light sensing elements may be sampled by a smaller number of ADCs than light sensing elements through the use of time multiplexing. For example, in one embodiment, system 100 may be configured to sample two or more of the analog electrical signals by switching the input of an ADC among the outputs of the two or more corresponding light sensing elements at a sufficiently high rate.

In some embodiments, the light sensing device 130 may include an array of light sensing elements. Arrays of any of a wide variety of sizes, configurations and material technologies are contemplated. In one embodiment, the light sensing device 130 includes a focal plane array coupled to a readout integrated circuit. In one embodiment, the light sensing device 130 may include an array of cells, where each cell includes a corresponding light sensing element and is configured to integrate and hold photo-induced charge created by the light sensing element, and to convert the integrated charge into a corresponding cell voltage. The light sensing device may also include (or couple to) circuitry configured to sample the cell voltages using one or more ADCs.

In some embodiments, the light sensing device 130 may include a plurality (or array) of light sensing elements, where each light sensing element is configured to receive a corresponding spatial portion of the modulated light stream, and each spatial portion of the modulated light stream comes from a corresponding sub-region of the array of light modulating elements. (For example, the light sensing device 130 may include a quadrant photodiode, where each quadrant of the photodiode is configured to receive modulated light from a corresponding quadrant of the array of light modulating elements. As another example, the light sensing device 130 may include a bi-cell photodiode. As yet another example, the light sensing device 130 may include a focal plane array.) Each light sensing element generates a corresponding signal representing intensity of the corresponding spatial portion as a function of time. Each signal may be digitized (e.g., by a corresponding ADC, or perhaps by a shared ADC) to obtain a corresponding sequence of samples. Thus, a plurality of sample sequences are obtained, one sample sequence per light sensing element. Each sample sequence may be processed to reconstruct a corresponding sub-image (or sub-video sequence). The sub-images may be joined together to form a whole image (or whole video sequence). The sample sequences may be captured in response to the modulation of the incident light stream with a sequence of M spatial patterns, e.g., as variously described above. By employing any of various reconstruction algorithms known in the field of compressive sensing, the number of pixels (voxels) in each reconstructed image (sub-video sequence) may be greater than (e.g., much greater than) M. To reconstruct each sub-image (sub-video), the reconstruction algorithm uses the corresponding sample sequence and the restriction of the spatial patterns to the corresponding sub-region of the array of light modulating elements.

In some embodiments, the light sensing device 130 includes a small number of light sensing elements (e.g., in respective embodiments, one, two, less than 8, less than 16, less the 32, less than 64, less than 128, less than 256). Because the light sensing device of these embodiments includes a small number of light sensing elements (e.g., far less than the typical modern CCD-based or CMOS-based camera), an entity interested in producing any of these embodiments may afford to spend more per light sensing element to realize features that are beyond the capabilities of modern array-based image sensors of large pixel count, e.g., features such as higher sensitivity, extended range of sensitivity, new range(s) of sensitivity, extended dynamic range, higher bandwidth/lower response time. Furthermore, because the light sensing device includes a small number of light sensing elements, an entity interested in producing any of these embodiments may use newer light sensing technologies (e.g., based on new materials or combinations of materials) that are not yet mature enough to be manufactured into focal plane arrays (FPA) with large pixel count. For example, new detector materials such as super-lattices, quantum dots, carbon nanotubes and graphene can significantly enhance the performance of IR detectors by reducing detector noise, increasing sensitivity, and/or decreasing detector cooling requirements.

In one embodiment, the light sensing device 130 is a thermo-electrically cooled InGaAs detector. (InGaAs stands for “Indium Gallium Arsenide”.) In other embodiments, the InGaAs detector may be cooled by other mechanisms (e.g., liquid nitrogen or a Sterling engine). In yet other embodiments, the InGaAs detector may operate without cooling. In yet other embodiments, different detector materials may be used, e.g., materials such as MCT (mercury-cadmium-telluride), InSb (Indium Antimonide) and VOx (Vanadium Oxide).

In different embodiments, the light sensing device 130 may be sensitive to light at different wavelengths or wavelength ranges. In some embodiments, the light sensing device 130 may be sensitive to light over a broad range of wavelengths, e.g., over the entire visible spectrum or over the entire range [λ_{L},λ_{U}] as defined above.

In some embodiments, the light sensing device 130 may include one or more dual-sandwich photodetectors. A dual sandwich photodetector includes two photodiodes stacked (or layered) one on top of the other.

In one embodiment, the light sensing device 130 may include one or more avalanche photodiodes.

In one embodiment, the light sensing device 130 may include one or more photomultiplier tubes (PMTs).

In some embodiments, a filter may be placed in front of the light sensing device 130 to restrict the modulated light stream to a specific range of wavelengths or specific polarization. Thus, the signal I_{MLS}(t) generated by the light sensing device 130 may be representative of the intensity of the restricted light stream. For example, by using a filter that passes only IR light, the light sensing device may be effectively converted into an IR detector. The sample principle may be applied to effectively convert the light sensing device into a detector for red or blue or green or UV or any desired wavelength band, or, a detector for light of a certain polarization.

In some embodiments, system 100 includes a color wheel whose rotation is synchronized with the application of the spatial patterns to the light modulation unit. As it rotates, the color wheel cyclically applies a number of optical bandpass filters to the modulated light stream MLS. Each bandpass filter restricts the modulated light stream to a corresponding sub-band of wavelengths. Thus, the samples captured by the ADC 140 will include samples of intensity in each of the sub-bands. The samples may be de-multiplexed to form separate sub-band sequences. Each sub-band sequence may be processed to generate a corresponding sub-band image. (As an example, the color wheel may include a red-pass filter, a green-pass filter and a blue-pass filter to support color imaging.)

In some embodiments, the system 100 may include a memory (or a set of memories of one or more kinds).

In some embodiments, system 100 may include a processing unit 150, e.g., as shown in FIG. 2B. The processing unit 150 may be a digital circuit or a combination of digital circuits. For example, the processing unit may be a microprocessor (or system of interconnected of microprocessors), a programmable hardware element such as a field-programmable gate array (FPGA), an application specific integrated circuit (ASIC), or any combination such elements. The processing unit 150 may be configured to perform one or more functions such as image/video reconstruction, system control, user interface, statistical analysis, and one or more inferences tasks.

The system 100 (e.g., the processing unit 150) may store the samples {I_{MLS}(k)} in a memory, e.g., a memory resident in the system 100 or in some other system.

In one embodiment, processing unit 150 is configured to operate on the samples {I_{MLS}(k)} to generate the image or video sequence. In this embodiment, the processing unit 150 may include a microprocessor configured to execute software (i.e., program instructions), especially software for performing an image/video reconstruction algorithm. In one embodiment, system 100 is configured to transmit the compensated samples to some other system through a communication channel. (In embodiments where the spatial patterns are randomly-generated, system 100 may also transmit the random seed(s) used to generate the spatial patterns.) That other system may operate on the samples to reconstruct the image/video. System 100 may have one or more interfaces configured for sending (and perhaps also receiving) data through one or more communication channels, e.g., channels such as wireless channels, wired channels, fiber optic channels, acoustic channels, laser-based channels, etc.

In some embodiments, processing unit 150 is configured to use any of a variety of algorithms and/or any of a variety of transformations to perform image/video reconstruction. System 100 may allow a user to choose a desired algorithm and/or a desired transformation for performing the image/video reconstruction.

In some embodiments, the system 100 is configured to acquire a set Z_{M} of samples from the ADC 140 so that the sample set Z_{M} corresponds to M of the spatial patterns applied to the light modulation unit 110, where M is a positive integer. The number M is selected so that the sample set Z_{M} is useable to reconstruct an n-pixel image or n-voxel video sequence that represents the incident light stream, where n is a positive integer less than or equal to the number N of light modulating elements in the light modulation unit 110. System 100 may be configured so that the number M is smaller than n. Thus, system 100 may operate as a compressive sensing device. (The number of “voxels” in a video sequence is the number of images in the video sequence times the number of pixels per image, or equivalently, the sum of the pixel counts of the images in the video sequence.)

In various embodiments, the compression ratio M/n may take any of a wide variety of values. For example, in different sets of embodiments, M/n may be, respectively, in the range [0.9,0.8], in the range [0.8,0.7], in the range [0.7,0.6], in the range [0.6,0.5], in the range [0.5,0.4], in the range [0.4,0.3], in the range [0.3,0.2], in the range [0.2,0.1], in the range [0.1,0.05], in the range [0.05,0.01], in the range [0.001,0.01].

Superpixels for Modulation at Lower Spatial Resolution

As noted above, the image reconstructed from the sample subset Z_{M} may be an n-pixel image with n≦N. The spatial patterns may be designed to support a value of n less than N, e.g., by forcing the array of light modulating elements to operate at a lower effective resolution than the physical resolution N. For example, the spatial patterns may be designed to force each 2×2 cell of light modulating elements to act in unison. At any given time, the modulation state of the four elements in a 2×2 cell will agree. Thus, the effective resolution of the array of light modulating elements is reduced to N/4. This principle generalizes to any cell size, to cells of any shape, and to collections of cells with non-uniform cell size and/or cell shape. For example, a collection of cells of size k_{H}×k_{V}, where k_{H} and k_{V} are positive integers, would give an effective resolution equal to N/(k_{H}k_{V}). In one alternative embodiment, cells near the center of the array may have smaller sizes than cells near the periphery of the array.

The “cells” of the above discussion are referred to herein as “superpixels”. When the reconstruction algorithm generates an image (video frame) from the acquired sample data, each superpixel corresponds to one pixel in the reconstructed image (video frame).

Restricting the Spatial Patterns to a Subset of the Modulation Array

Another way the spatial patterns may be arranged to support the reconstruction of an n-pixel image with n less than N is to allow the spatial patterns to vary only within a subset (or region) of the array of light modulating elements. In this mode of operation, the spatial patterns are null (take the value zero) outside the subset. (Control unit 120 may be configured to implement this restriction of the spatial patterns.) Light modulating elements corresponding to positions outside of the subset do not send any light (or send only the minimum amount of light attainable) to the light sensing device. Thus, the reconstructed image is restricted to the subset. In some embodiments, each spatial pattern (e.g., of a measurement pattern sequence) may be multiplied element-wise by a binary mask that takes the one value only in the allowed subset, and the resulting product pattern may be supplied to the light modulation unit. In some embodiments, the subset is a contiguous region of the array of light modulating elements, e.g., a rectangle or a circular disk or a hexagon. In some embodiments, the size and/or position of the region may vary (e.g., dynamically). The position of the region may vary in order to track a moving object. The size of the region may vary in order to dynamically control the rate of image acquisition or video frame rate. In some embodiments, the size of the region may be determined by user input. For example, system 100 may provide an input interface (GUI and/or mechanical control device) through which the user may vary the size of the region over a continuous range of values (or alternatively, a discrete set of values), thereby implementing a digital zoom function. Furthermore, in some embodiments, the position of the region within the field of view may be controlled by user input.

Oversampling Relative to Pattern Modulation Rate

In some embodiments, the A/D converter 140 may oversample the electrical signal generated by the light sensing device 130, i.e., acquire samples of the electrical signal at a rate higher than (e.g., a multiple of) the pattern modulation rate. The pattern modulation rate is the rate at which the spatial patterns are applied to the incident light stream L by the light modulation unit 110. Thus, the A/D converter may generate a plurality of samples per spatial pattern. The plurality of samples may be averaged to obtain a single averaged sample per spatial pattern. The averaging tends to reduce noise, and thus, to increase quality of image reconstruction. The averaging may be performed by processing unit 150 or some other processing agent. The oversampling ratio may be controlled by setting the pattern modulation rate and/or setting the A/D sampling rate.

In one embodiment, system 100 may include a light transmitter configured to generate a light beam (e.g., a laser beam), to modulate the light beam with a data signal and to transmit the modulated light beam into space or onto an optical fiber. System 100 may also include a light receiver configured to receive a modulated light beam from space or from an optical fiber, and to recover a data stream from the received modulated light beam.

In one embodiment, system 100 may be configured as a low-cost sensor system having minimal processing resources, e.g., processing resources insufficient to perform image (or video) reconstruction in user-acceptable time. In this embodiment, the system 100 may store and/or transmit the samples {I_{MLS}(k)} so that another agent, more plentifully endowed with processing resources, may perform the image/video reconstruction based on the samples.

In some embodiments, system 100 may include an optical subsystem 105 that is configured to modify or condition the light stream L before it arrives at the light modulation unit 110, e.g., as shown in FIG. 2C. For example, the optical subsystem 105 may be configured to receive the light stream L from the environment and to focus the light stream onto a modulating plane of the light modulation unit 110. The optical subsystem 105 may include a camera lens (or a set of lenses). The lens (or set of lenses) may be adjustable to accommodate a range of distances to external objects being imaged/sensed/captured. The optical subsystem 105 may allow manual and/or digital control of one or more parameters such as focus, zoom, shutter speed and f-stop.

In some embodiments, system 100 may include an optical subsystem 117 to direct the modulated light stream MLS onto a light sensing surface (or surfaces) of the light sensing device 130.

In some embodiments, the optical subsystem 117 may include one or more lenses, and/or, one or more mirrors.

In some embodiments, the optical subsystem 117 is configured to focus the modulated light stream onto the light sensing surface (or surfaces). The term “focus” implies an attempt to achieve the condition that rays (photons) diverging from a point on an object plane converge to a point (or an acceptably small spot) on an image plane. The term “focus” also typically implies continuity between the object plane point and the image plane point (or image plane spot); points close together on the object plane map respectively to points (or spots) close together on the image plane. In at least some of the system embodiments that include an array of light sensing elements, it may be desirable for the modulated light stream MLS to be focused onto the light sensing array so that there is continuity between points on the light modulation unit LMU and points (or spots) on the light sensing array.

In some embodiments, the optical subsystem 117 may be configured to direct the modulated light stream MLS onto the light sensing surface (or surfaces) of the light sensing device 130 in a non-focusing fashion. For example, in a system embodiment that includes only one photodiode, it may not be so important to achieve the “in focus” condition at the light sensing surface of the photodiode since positional information of photons arriving at that light sensing surface will be immediately lost.

In one embodiment, the optical subsystem 117 may be configured to receive the modulated light stream and to concentrate the modulated light stream into an area (e.g., a small area) on a light sensing surface of the light sensing device 130. Thus, the diameter of the modulated light stream may be reduced (possibly, radically reduced) in its transit from the optical subsystem 117 to the light sensing surface (or surfaces) of the light sensing device 130. For example, in some embodiments, the diameter may be reduced by a factor of more than 1.5 to 1. In other embodiments, the diameter may be reduced by a factor of more than 2 to 1. In yet other embodiments, the diameter may be reduced by a factor of more than 10 to 1. In yet other embodiments, the diameter may be reduced by factor of more than 100 to 1. In yet other embodiments, the diameter may be reduced by factor of more than 400 to 1. In one embodiment, the diameter is reduced so that the modulated light stream is concentrated onto the light sensing surface of a single light sensing element (e.g., a single photodiode).

In some embodiments, this feature of concentrating the modulated light stream onto the light sensing surface (or surfaces) of the light sensing device allows the light sensing device to sense at any given time the sum (or surface integral) of the intensities of the modulated light portions within the modulated light stream. (Each time slice of the modulated light stream comprises a spatial ensemble of modulated light portions due to the modulation unit's action of applying the corresponding spatial pattern to the light stream.)

In some embodiments, the modulated light stream MLS may be directed onto the light sensing surface of the light sensing device 130 without concentration, i.e., without decrease in diameter of the modulated light stream, e.g., by use of photodiode having a large light sensing surface, large enough to contain the cross section of the modulated light stream without the modulated light stream being concentrated.

In some embodiments, the optical subsystem 117 may include one or more lenses. FIG. 2E shows an embodiment where optical subsystem 117 is realized by a lens 117L, e.g., a biconvex lens or a condenser lens.

In some embodiments, the optical subsystem 117 may include one or more mirrors. In one embodiment, the optical subsystem 117 includes a parabolic mirror (or spherical mirror) to concentrate the modulated light stream onto a neighborhood (e.g., a small neighborhood) of the parabolic focal point. In this embodiment, the light sensing surface of the light sensing device may be positioned at the focal point.

In some embodiments, system 100 may include an optical mechanism (e.g., an optical mechanism including one or more prisms and/or one or more diffraction gratings) for splitting or separating the modulated light stream MLS into two or more separate streams (perhaps numerous streams), where each of the streams is confined to a different wavelength range. The separate streams may each be sensed by a separate light sensing device. (In some embodiments, the number of wavelength ranges may be, e.g., greater than 8, or greater than 16, or greater than 64, or greater than 256, or greater than 1024.) Furthermore, each separate stream may be directed (e.g., focused or concentrated) onto the corresponding light sensing device as described above in connection with optical subsystem 117. The samples captured from each light sensing device may be used to reconstruct a corresponding image (or video sequence) for the corresponding wavelength range. In one embodiment, the modulated light stream is separated into red, green and blue streams to support color (R,G,B) measurements. In another embodiment, the modulated light stream may be separated into IR, red, green, blue and UV streams to support five-channel multi-spectral imaging: (IR, R, G, B, UV). In some embodiments, the modulated light stream may be separated into a number of sub-bands (e.g., adjacent sub-bands) within the IR band to support multi-spectral or hyper-spectral IR imaging. In some embodiments, the number of IR sub-bands may be, e.g., greater than 8, or greater than 16, or greater than 64, or greater than 256, or greater than 1024. In some embodiments, the modulated light stream may experience two or more stages of spectral separation. For example, in a first stage the modulated light stream may be separated into an IR stream confined to the IR band and one or more additional streams confined to other bands. In a second stage, the IR stream may be separated into a number of sub-bands (e.g., numerous sub-bands) (e.g., adjacent sub-bands) within the IR band to support multispectral or hyper-spectral IR imaging.

In some embodiments, system 100 may include an optical mechanism (e.g., a mechanism including one or more beam splitters) for splitting or separating the modulated light stream MLS into two or more separate streams, e.g., where each of the streams have the same (or approximately the same) spectral characteristics or wavelength range. The separate streams may then pass through respective bandpass filters to obtain corresponding modified streams, where each modified stream is restricted to a corresponding band of wavelengths. Each of the modified streams may be sensed by a separate light sensing device. (In some embodiments, the number of wavelength bands may be, e.g., greater than 8, or greater than 16, or greater than 64, or greater than 256, or greater than 1024.) Furthermore, each of the modified streams may be directed (e.g., focused or concentrated) onto the corresponding light sensing device as described above in connection with optical subsystem 117. The samples captured from each light sensing device may be used to reconstruct a corresponding image (or video sequence) for the corresponding wavelength band. In one embodiment, the modulated light stream is separated into three streams which are then filtered, respectively, with a red-pass filter, a green-pass filter and a blue-pass filter. The resulting red, green and blue streams are then respectively detected by three light sensing devices to support color (R,G,B) acquisition. In another similar embodiment, five streams are generated, filtered with five respective filters, and then measured with five respective light sensing devices to support (IR, R, G, B, UV) multi-spectral acquisition. In yet another embodiment, the modulated light stream of a given band may be separated into a number of (e.g., numerous) sub-bands to support multi-spectral or hyper-spectral imaging.

In some embodiments, system 100 may include an optical mechanism for splitting or separating the modulated light stream MLS into two or more separate streams. The separate streams may be directed to (e.g., concentrated onto) respective light sensing devices. The light sensing devices may be configured to be sensitive in different wavelength ranges, e.g., by virtue of their different material properties. Samples captured from each light sensing device may be used to reconstruct a corresponding image (or video sequence) for the corresponding wavelength range.

In some embodiments, system 100 may include a control unit 120 configured to supply the spatial patterns to the light modulation unit 110, as shown in FIG. 2F. The control unit may itself generate the patterns or may receive the patterns from some other agent. The control unit 120 and the ADC 140 may be controlled by a common clock signal so that ADC 140 can coordinate (synchronize) its action of capturing the samples {I_{MLS}(k)} with the control unit's action of supplying spatial patterns to the light modulation unit 110. (System 100 may include clock generation circuitry.)

In some embodiments, the control unit 120 may supply the spatial patterns to the light modulation unit in a periodic fashion.

The control unit 120 may be a digital circuit or a combination of digital circuits. For example, the control unit may include a microprocessor (or system of interconnected of microprocessors), a programmable hardware element such as a field-programmable gate array (FPGA), an application specific integrated circuit (ASIC), or any combination such elements.

In some embodiments, the control unit 120 may include a random number generator (RNG) or a set of random number generators to generate the spatial patterns or some subset of the spatial patterns.

In some embodiments, system 100 is battery powered. In some embodiments, the system 100 includes a set of one or more solar cells and associated circuitry to derive power from sunlight.

In some embodiments, system 100 includes its own light source for illuminating the environment or a target portion of the environment.

In some embodiments, system 100 may include a display (or an interface configured for coupling to a display) for displaying reconstructed images/videos.

In some embodiments, system 100 may include one or more input devices (and/or, one or more interfaces for input devices), e.g., any combination or subset of the following devices: a set of buttons and/or knobs, a keyboard, a keypad, a mouse, a touch-sensitive pad such as a trackpad, a touch-sensitive display screen, one or more microphones, one or more temperature sensors, one or more chemical sensors, one or more pressure sensors, one or more accelerometers, one or more orientation sensors (e.g., a three-axis gyroscopic sensor), one or more proximity sensors, one or more antennas, etc.

Regarding the spatial patterns that are used to modulate the light stream L, it should be understood that there are a wide variety of possibilities. In some embodiments, the control unit 120 may be programmable so that any desired set of spatial patterns may be used.

In some embodiments, the spatial patterns are binary valued. Such an embodiment may be used, e.g., when the light modulating elements are two-state devices. In some embodiments, the spatial patterns are n-state valued, where each element of each pattern takes one of n states, where n is an integer greater than two. (Such an embodiment may be used, e.g., when the light modulating elements are each able to achieve n or more modulation states). In some embodiments, the spatial patterns are real valued, e.g., when each of the light modulating elements admits a continuous range of modulation. (It is noted that even a two-state modulating element may be made to effectively apply a continuous range of modulation by duty cycling the two states during modulation intervals.)

Coherence

The spatial patterns may belong to a set of measurement vectors that is incoherent with a set of vectors in which the image/video is approximately sparse (“the sparsity vector set”). (See “Sparse Signal Detection from Incoherent Projections”, Proc. Int. Conf. Acoustics, Speech Signal Processing—ICASSP, May 2006, Duarte et al.) Given two sets of vectors A={aᵢ} and B={bᵢ} in the same N-dimensional space, A and B are said to be incoherent if their coherence measure μ(A,B) is sufficiently small. Assuming that the vectors {aᵢ} and {bᵢ} each have unit L² norm, then coherence measure may be defined as:

$$μ ( A , B ) = {max}_{i , j} \vert 〈 {a}_{i} , {b}_{j} 〉 \vert .$$

The number of compressive sensing measurements (i.e., samples of the sequence {I_{MLS}(k)} needed to reconstruct an N-pixel image (or N-voxel video sequence) that accurately represents the scene being captured is a strictly increasing function of the coherence between the measurement vector set and the sparsity vector set. Thus, better compression can be achieved with smaller values of the coherence.

In some embodiments, the measurement vector set may be based on a code. Any of various codes from information theory may be used, e.g., codes such as exponentiated Kerdock codes, exponentiated Delsarte-Goethals codes, run-length limited codes, LDPC codes, Reed Solomon codes and Reed Muller codes.

In some embodiments, the measurement vector set corresponds to a randomized or permuted basis, where the basis may be, for example, the DCT basis (DCT is an acronym for Discrete Cosine Transform) or Hadamard basis.

In some embodiments, the spatial patterns may be random or pseudo-random patterns, e.g., generated according to a random number generation (RNG) algorithm using one or more seeds. In some embodiments, the elements of each pattern are generated by a series of Bernoulli trials, where each trial has a probability p of giving the value one and probability 1−p of giving the value zero. (For example, in one embodiment p=1/2.) In some embodiments, the elements of each pattern are generated by a series of draws from a Gaussian random variable.)

The system 100 may be configured to operate in a compressive fashion, where the number of the samples {I_{MLS}(k)} captured by the system 100 is less than (e.g., much less than) the number of pixels in the image (or video) to be reconstructed from the samples. In many applications, this compressive realization is very desirable because it saves on power consumption, memory utilization and transmission bandwidth consumption. However, non-compressive realizations are contemplated as well.

In some embodiments, the system 100 is configured as a camera or imager that captures information representing an image (or a series of images) from the external environment, e.g., an image (or a series of images) of some external object or scene. The camera system may take different forms in different application domains, e.g., domains such as visible light photography, infrared photography, ultraviolet photography, high-speed photography, low-light photography, underwater photography, multi-spectral imaging, hyper-spectral imaging, etc. In some embodiments, system 100 is configured to operate in conjunction with (or as part of) another system, e.g., in conjunction with (or as part of) a microscope, a telescope, a robot, a security system, a surveillance system, a fire sensor, a node in a distributed sensor network, etc.

In some embodiments, system 100 is configured as a spectrometer.

In some embodiments, system 100 is configured as a multi-spectral or hyper-spectral imager.

In some embodiments, system 100 may configured as a single integrated package, e.g., as a camera.

In some embodiments, system 100 may also be configured to operate as a projector. Thus, system 100 may include a light source, e.g., a light source located at or near a focal point of optical subsystem 117. In projection mode, the light modulation unit 110 may be supplied with an image (or a sequence of images), e.g., by control unit 120. The light modulation unit may receive a light beam generated by the light source, and modulate the light beam with the image (or sequence of images) to obtain a modulated light beam. The modulated light beam exits the system 100 and is displayed on a display surface (e.g., an external screen).

In one embodiment, the light modulation unit 110 may receive the light beam from the light source and modulate the light beam with a time sequence of spatial patterns (from a measurement pattern set). The resulting modulated light beam exits the system 100 and is used to illuminate the external scene. Light reflected from the external scene in response to the modulated light beam is measured by a light sensing device (e.g., a photodiode). The samples captured by the light sensing device comprise compressive measurements of external scene. Those compressive measurements may be used to reconstruct an image or video sequence as variously described above.

In some embodiments, system 100 includes an interface for communicating with a host computer. The host computer may send control information and/or program code to the system 100 via the interface. Furthermore, the host computer may receive status information and/or compressive sensing measurements from system 100 via the interface.

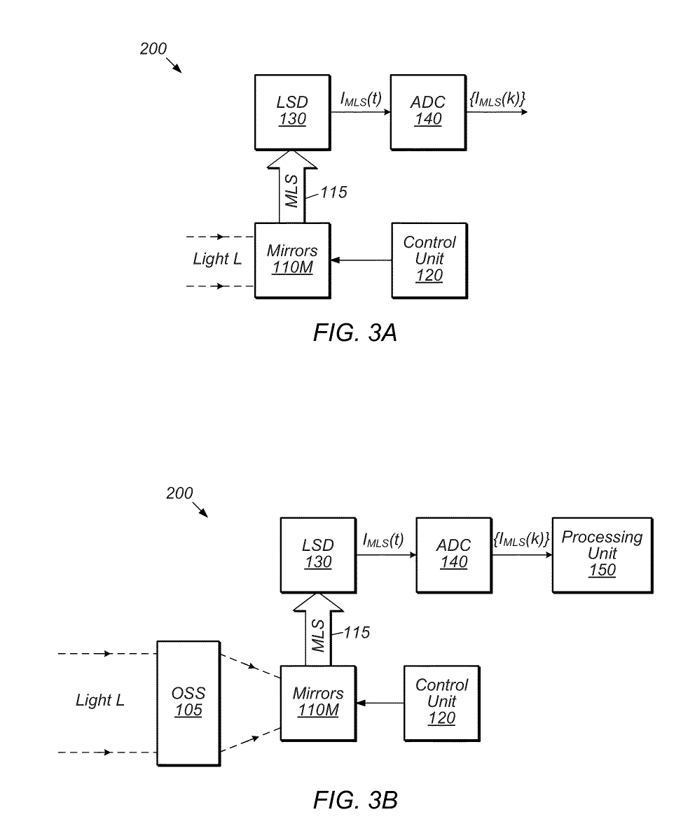

In one realization 200 of system 100, the light modulation unit 110 may be realized by a plurality of mirrors, e.g., as shown in FIG. 3A. (The mirrors are collectively indicated by the label 110M.) The mirrors 110M are configured to receive corresponding portions of the light L received from the environment, albeit not necessarily directly from the environment. (There may be one or more optical elements, e.g., one or more lenses along the input path to the mirrors 110M.) Each of the mirrors is configured to controllably switch between at least two orientation states. In addition, each of the mirrors is configured to (a) reflect the corresponding portion of the light onto a sensing path 115 when the mirror is in a first of the two orientation states and (b) reflect the corresponding portion of the light away from the sensing path when the mirror is in a second of the two orientation states.

In some embodiments, the mirrors 110M are arranged in an array, e.g., a two-dimensional array or a one-dimensional array. Any of various array geometries are contemplated. For example, in different embodiments, the array may be a square array, a rectangular array, a hexagonal array, etc. In some embodiments, the mirrors are arranged in a spatially-random fashion.

The mirrors 110M may be part of a digital micromirror device (DMD). For example, in some embodiments, one of the DMDs manufactured by Texas Instruments may be used.

The control unit 120 may be configured to drive the orientation states of the mirrors through the series of spatial patterns, where each of the patterns of the series specifies an orientation state for each of the mirrors.

The light sensing device 130 may be configured to receive the light portions reflected at any given time onto the sensing path 115 by the subset of mirrors in the first orientation state and to generate an analog electrical signal I_{MLS}(t) representing a cumulative intensity of the received light portions as function of time. As the mirrors are driven through the series of spatial patterns, the subset of mirrors in the first orientation state will vary from one spatial pattern to the next. Thus, the cumulative intensity of light portions reflected onto the sensing path 115 and arriving at the light sensing device will vary as a function time. Note that the term “cumulative” is meant to suggest a summation (spatial integration) over the light portions arriving at the light sensing device at any given time. This summation may be implemented, at least in part, optically (e.g., by means of a lens and/or mirror that concentrates or focuses the light portions onto a concentrated area as described above).

System realization 200 may include any subset of the features, embodiments and elements discussed above with respect to system 100. For example, system realization 200 may include the optical subsystem 105 to operate on the incoming light L before it arrives at the mirrors 110M, e.g., as shown in FIG. 3B.

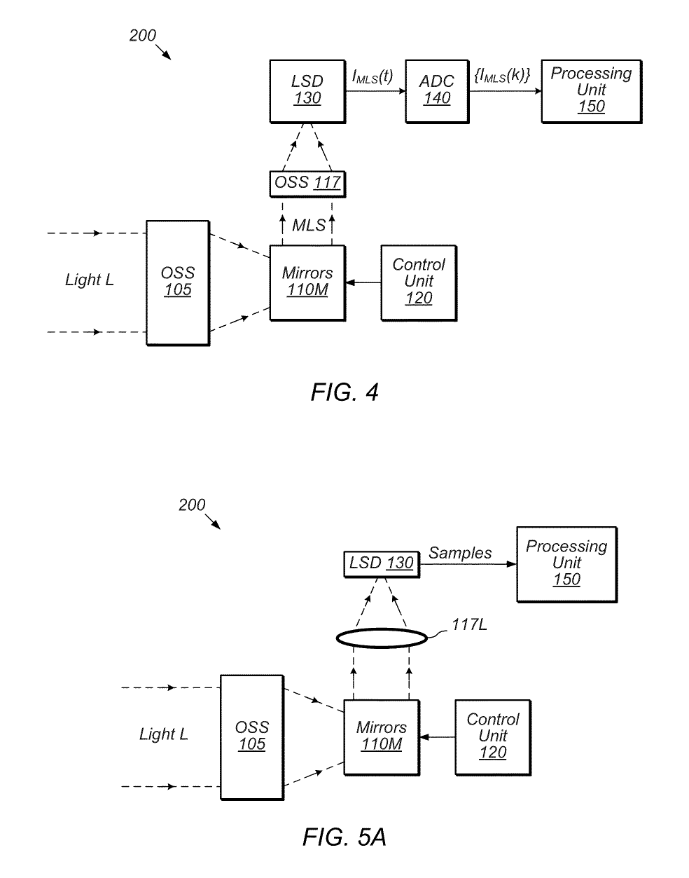

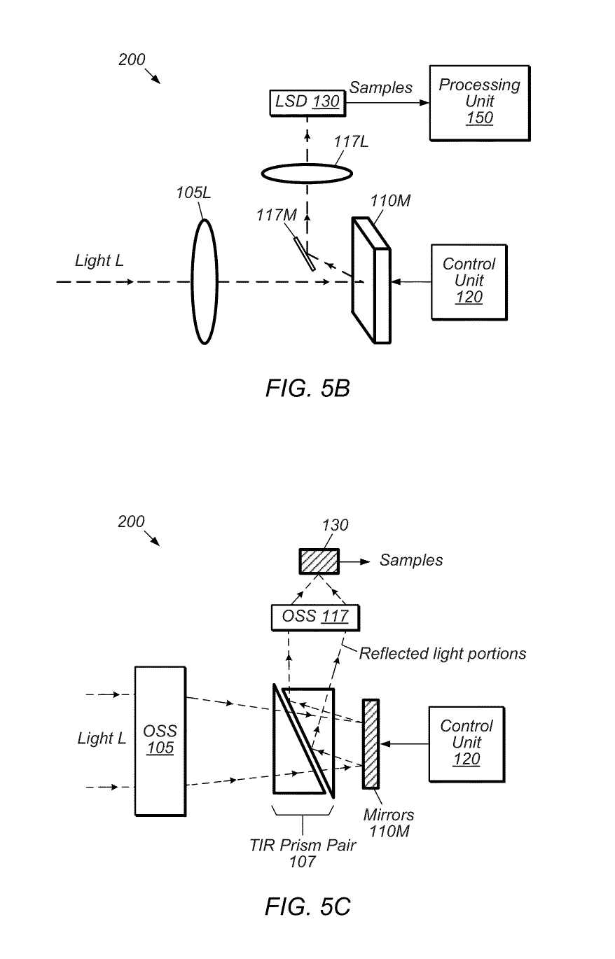

In some embodiments, system realization 200 may include the optical subsystem 117 along the sensing path as shown in FIG. 4. The optical subsystem 117 receives the light portions reflected onto the sensing path 115 and directs (e.g., focuses or concentrates) the received light portions onto a light sensing surface (or surfaces) of the light sensing device 130. In one embodiment, the optical subsystem 117 may include a lens 117L, e.g., as shown in FIG. 5A.

In some embodiments, the optical subsystem 117 may include one or more mirrors, e.g., a mirror 117M as shown in FIG. 5B. Thus, the sensing path may be a bent path having more than one segment. FIG. 5B also shows one possible embodiment of optical subsystem 105, as a lens 105L.

In some embodiments, there may be one or more optical elements intervening between the optical subsystem 105 and the mirrors 110M. For example, as shown in FIG. 5C, a TIR prism pair 107 may be positioned between the optical subsystem 105 and the mirrors 110M. (TIR is an acronym for “total internal reflection”.) Light from optical subsystem 105 is transmitted through the TIR prism pair and then interacts with the mirrors 110M. After having interacted with the mirrors 110M, light portions from mirrors in the first orientation state are reflected by a second prism of the pair onto the sensing path 115. Light portions from mirrors in the second orientation state may be reflected away from the sensing path.

While many of the embodiments described herein involve the modulation of light signals, it should be understood that the principles of the present invention are not limited to light signals. Various embodiments are contemplated where the signals being processed are, e.g., electromagnetic signals or particle beams or seismic signals or acoustic signals or chemical signals or thermal signals or surface waves on a boundary between two fluids or gravitational waves. In each case, a space-time signal is directed to an array of signal-modulating elements whose transmittances or reflectances are individually varied so as to modulate the space-time signal with a time sequence of spatial patterns. The modulated space-time signal may be sensed by a transducer to generate an electrical signal that represents intensity of the modulated space-time signal as a function of time. The electrical signal is sampled to obtain measurements. The measurements may be processed as variously described above to reconstruct an image or sequence of images carried by the original space-time signal.

While many of the embodiments described herein involve the modulation of space-time signals, it should be understood that the principles of the present invention may be applied to signals that are modeled as a real-valued or complex-valued function of time f(t). Signal modulation may be achieved by applying a sequence {Pⱼ} of one-dimensional patterns to the signal f(t) to obtain a corresponding sequence {Sⱼ} of measurements (inner products). For example, the application of each pattern Pⱼ to the signal f(t) may be modeled by the expression

Sⱼ=Σₖ₌₁^{N}f(tₖ)Pⱼ(k).

Affine-Harmonically Related Rows of Kronecker-Product Matrices

A fast method for loading patterns onto a signal modulating array such as digital micromirror device (DMD) is described below. A generic pattern may have the property that it reuses portions of a previous pattern. Thus, less data needs to be transferred to affect the loading of the generic pattern, increasing the overall rate of pattern loading. The method is applicable to patterns derived from rows of matrices constructed from Kronecker products, such as Hadamard matrices.

Given two arbitrary binary-valued matrices H_{B} and H_{F} of size B×B and F×F, respectively, it is well known that their Kronecker product H_{F} [symbol] H_{B} results in another binary-valued matrix of size BF×BF. Without loss of generality, assume that the binary values are {+1,−1}. This form of the Kronecker product means that all of the +1 s in H_{F} are replaced +H_{B}, and all of the −1 s in H_{F} are replaced with −H_{R}. Henceforth we focus specifically on Hadamard matrices, but the principles described herein also apply to other binary-valued Kronecker-product matrices, and to general Kronecker-product matrices whose values are not necessarily binary-valued.

Introduction/Overview

The process of loading and displaying data onto a DMD involves several steps. Here we only focus on optimizing the step of data loading. We ignore the time allocated for resetting the memory buffers and for mirror settling, etc., which in general cannot be changed for a particular DMD.

Assume the DMD has N mirrors, and that we draw M rows from an N×N Hadamard matrix H_{N}. We want to reshape/wrap each of these length-N rows onto the DMD, one at a time. Assume that each entry in H_{N} is a +1 or a −1 that we can map to a logical 1 or 0, respectively, which correspond to the “on” or “off” state of the individual mirrors on the DMD. Therefore, each row contains N bits of information, and we need communicate this to the DMD in order to display each binary pattern. Overall, we need to transfer M·N bits of information, since there are M different rows/patterns.

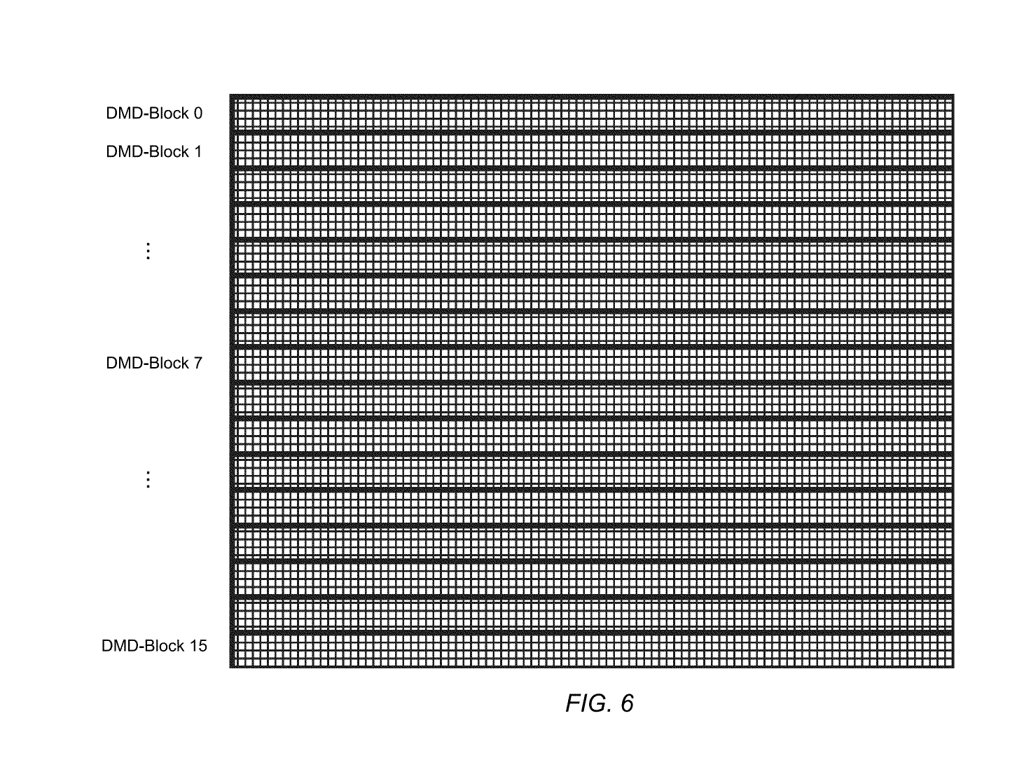

Consider the XGA-format DMD, which has 768 rows and 1024 columns for a total of N=768×1024=12·2¹⁶ mirrors. FIG. 6 shows the specific case where the 768 rows are broken up into 16 non-overlapping DMD-blocks, each with 48 rows. (We use the term “block” in two different ways. In one case, a block is a set of rows of the DMD that together contain exactly B mirrors, e.g., seen in FIG. 6. In the other case, a block, denoted with the symbol [symbol] , is a mathematical structure: a B×N submatrix of a larger N×N matrix, e.g., in Equations (2) and (7). The former case is referred to as a DMD-block and the latter as a matrix-block. Note the block parameter B that is common to both. Similarly, the term “row” is also used in two different ways: we draw rows, one at a time, from a matrix-block of H_{N} and, after reshaping them, load their elements onto the rows of the DMD, which are divided into their own DMD-blocks.) According to the manufacturer, Texas Instruments, this is the maximum number of possible DMD-blocks for this particular device. However, these blocks can be grouped together in other combinations. For example, DMD-blocks 0-7 and DMD-blocks 8-15 can be grouped together, which would effectively create just 2 large DMD-blocks. Various other combinations are possible.

Suppose that it takes T seconds to load just one of these 16 DMD-blocks. Then it will take 16T seconds to load all of the 16 DMD-blocks, and ignoring other issues, it will take

T₀=M·16T (1)

seconds to load all of the M patterns.

While the present embodiment is described in terms of a particular DMD, having a particular constraint on the number of DMD-blocks, it should be understood that inventive principles herein described apply more generally to any signal modulating array having any number modulation blocks. Suppose that a modulation device has separately programmable modulation blocks, and that each modulation block takes T seconds to load. Then equation (1) above can be phrased as

T₀=M·ηT.

Similarly, the other examples and formulas presented here can be easily generalized in a similar way.

Simple Case: 2 DMD-Blocks

Instead of sixteen DMD-blocks, let us first examine the case just described, where we merge DMD-blocks 0-7, and 8-15 together into 2 large DMD-blocks, each with B=N/2=12·2¹⁵ mirrors. Since, a B×B Hadamard matrix exists for this value of B, we can express the N×N Hadamard matrix as

$${H}_{N} = {H}_{2} {H}_{B} = [ \begin{matrix}+ {H}_{B} & + {H}_{B} \\ + {H}_{B} & - {H}_{B}\end{matrix} ] = [ \begin{matrix}{B}_{0} \\ {B}_{1}\end{matrix} ] , \qquad ( 2 )$$

where matrix-blocks [symbol] ₀ and [symbol] ₁ are each B×N.

Suppose that we want to draw M rows from this Hadamard matrix and wrap them, one at a time, onto the DMD in the “row-majorized” sense (a “column-majorized” version is also possible). If purely random rows are desired, then the row indices may be chosen according to some probability distribution. For example, the ith row index mᵢ can be chosen uniformly at random:

mᵢ=rand(0, . . . ,N−1).

However, we can sacrifice some randomness and gain some benefit from a partial deterministic method of the row selection process. For simplicity, assume M is an even number. Then we can assign exactly half, M/2, of these rows indices to be completely random integers in the range of 0 to B−1, e.g., these rows are drawn uniformly at random from matrix-block [symbol] ₀ in Equation (2). Then we deterministically choose the other M/2 rows from matrix-block [symbol] ₁ that are “affine-harmonically related” to the ones drawn from [symbol] ₀: we simply add B to the random row indices of [symbol] ₀. For example, consider the 3rd row of [symbol] ₀; its “affine-harmonically related” row corresponds to the 3rd row of matrix-block [symbol] ₁.

In total, we draw M quasi-random row indices according to

$${m}_{i} = \{ \begin{matrix}rand ( 0 , … , B - 1 ) , & i = 0 , … , \frac{M}{2} - 1 \\ {m}_{i - M / 2} + B , & i = \frac{M}{2} , … , M - 1.\end{matrix} \qquad ( 3 )$$

Notice in Equation (2) that the second copy of H_{B} in matrix-block [symbol] ₀ is +H_{B}, while the second copy of H_{B}; in matrix-block [symbol] ₁ has been negated: −H_{B}. Thus, the first B=N/2 columns of matrix-blocks [symbol] ₀ and [symbol] ₁ are the same, while the second group of B columns of matrix-blocks [symbol] ₀ and [symbol] ₁ are different. Hence, comparing any two affine-harmonically related rows in Equation (3) reveals that the only “new” information is contained in their second set of B elements. Moreover, when these rows are reshaped and loaded onto the DMD, the location of their difference corresponds exactly to the lower half of the DMD. (Ideally, we don't need to load any “new” information. We simply need to negate the data that is already in the lower half of the DMD. However, to the best of my knowledge, once data is loaded into the DMD memory registers and the mirrors are reset to take on these binary states, then we cannot reuse that stored memory. Thus we must reload the negated pattern.)

Therefore, after a random row from matrix-block [symbol] ₀ has been loaded onto the DMD, the next row loaded should be its affine-harmonically related row from matrix-block [symbol] ₁. Then the next random row from [symbol] ₀ should be loaded, which would be immediately followed by its affine-harmonically related row from [symbol] ₁, and so on.

The time to fully load just the M/2 random rows will take

$${T}_{2 , rand} = \frac{M}{2} \cdot 16 T \qquad ( 4 )$$

seconds, and the time to load just the M/2 affine-harmonically related rows will take

$${T}_{2 , harm} = \frac{M}{2} \cdot \frac{16}{2} T \qquad ( 5 )$$

seconds. Equation (5) has an extra factor of ½ since only half of the N elements comprising each row needs to be loaded, and where it is assumed that this “new” data lines up perfectly with exactly half of the 16 DMD-blocks (i.e., DMD-blocks 8-15). Adding Equations (4) and (5) we find that the total time to load the M patterns for this scenario will be

$${T}_{2} = {T}_{2 , rand} + {T}_{2 , harm} = \frac{3}{4} ( M \cdot 16 T ) . \qquad ( 6 )$$

Compared to Equation (1), this would provide a speed-up of factor of ¾.

General Case: F DMD-Blocks

It is straightforward to extend this idea to utilize even fewer randomly selected rows and more affine-harmonically related ones. (These affine-harmonically related rows also differ from each other in exactly N/2 locations. In fact, it can be shown that all rows of an N×N Hadamard matrix H_{N} differ from all other rows by exactly N/2. This is sometimes stated as the fact that Hadamard matrices have a maximum Hamming distance of 50%. However, we specifically want to utilize the rows of H_{N} that, when reshaped, differ with each other in a way that lines up precisely with the bus architecture of the DMD-blocks.) In general, set F=2^{K} for some integer K as our “affine-harmonically related” factor. This corresponds to a partitioning of the DMD into F DMD-blocks, with block parameter B=N/F. Hence, if a B×B Hadamard matrix exists, then the full N×N Hadamard matrix can be viewed as

$$\begin{matrix}{H}_{N} = {H}_{F} {H}_{B} , \\ or & ( 7 ) \\ \begin{matrix}{H}_{N} = [ \begin{matrix}+ {H}_{B} & + {H}_{B} & + {H}_{B} & + {H}_{B} & + {H}_{B} & + {H}_{B} & … & + {H}_{B} \\ + {H}_{B} & - {H}_{B} & + {H}_{B} & - {H}_{B} & + {H}_{B} & - {H}_{B} & … & - {H}_{B} \\ + {H}_{B} & + {H}_{B} & - {H}_{B} & - {H}_{B} & + {H}_{B} & + {H}_{B} & … & - {H}_{B} \\ + {H}_{B} & - {H}_{B} & - {H}_{B} & + {H}_{B} & + {H}_{B} & - {H}_{B} & … & + {H}_{B} \\ + {H}_{B} & + {H}_{B} & + {H}_{B} & + {H}_{B} & - {H}_{B} & - {H}_{B} & … & - {H}_{B} \\ + {H}_{B} & - {H}_{B} & + {H}_{B} & - {H}_{B} & - {H}_{B} & + {H}_{B} & … & + {H}_{B} \\ ⋮ & ⋮ & ⋮ & ⋮ & ⋮ & ⋮ & ⋱ & ⋮ \\ + {H}_{B} & - {H}_{B} & - {H}_{B} & + {H}_{B} & - {H}_{B} & + {H}_{B} & … & ⋱\end{matrix} ] \\ = [ \begin{matrix}{B}_{0} \\ {B}_{1} \\ {B}_{2} \\ {B}_{3} \\ {B}_{4} \\ {B}_{5} \\ ⋮ \\ {B}_{F - 1}\end{matrix} ] .\end{matrix} & \end{matrix}$$

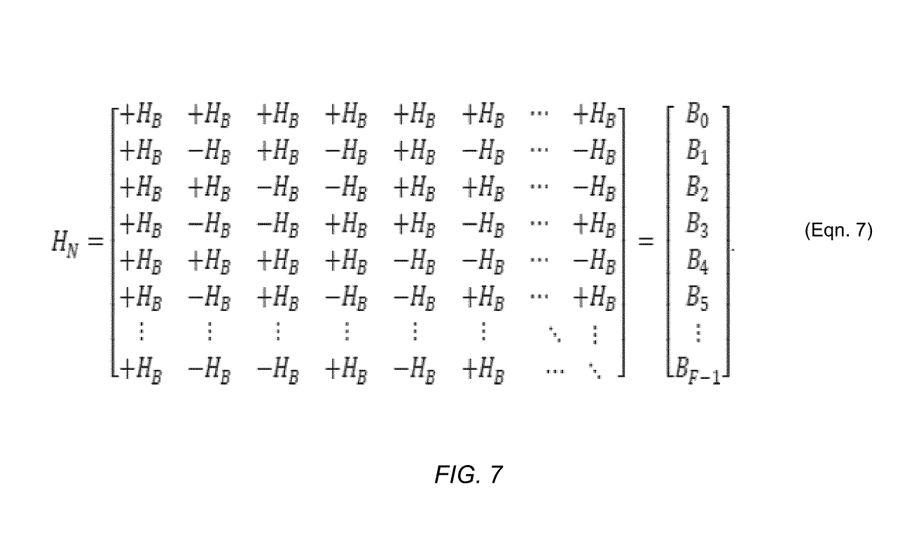

(For the reader's convenience, equation (7) is duplicated with enlarged size in FIG. 7.) In this general scenario, assume that a random row from matrix-block [symbol] ₀ has been loaded onto the DMD. From Equation (7) we see that we should then successively load its F−1 affine-harmonically related rows, one at a time, from matrix-blocks [symbol] ₁, [symbol] ₂, . . . , B_{F-1}. For example, if the 3rd row of [symbol] ₀ had been selected as a randomly chosen row, then its affine-harmonically related rows correspond to the 3rd row of matrix-blocks [symbol] ₁, [symbol] ₂, . . . , [symbol] _{F-1}. After the affine-harmonically related rows have been “flushed out,” the next purely random row from [symbol] ₀ should be loaded, and its affine-harmonically related rows from [symbol] ₁, [symbol] ₂, . . . , [symbol] _{F-1} should follow, one at a time, and so on.

Extending Equation (3) to the general case of F=2^{K}, the M quasi-randomly chosen row indices become (assume for simplicity that M is divisible by F):

$${m}_{i} = \{ \begin{matrix}rand ( 0 , … , B - 1 ) , & i = 0 , … , \frac{M}{F} - 1 \\ {m}_{i - M / F} + B , & i = \frac{M}{F} , … , \frac{2 M}{F} - 1 \\ {m}_{i - 2 M / F} + 2 B , & i = \frac{2 M}{F} , … , \frac{3 M}{F} - 1 \\ ⋮ & ⋮ \\ {m}_{i - ( F - 1 ) M / F} + ( F - 1 ) B , & i = \frac{( F - 1 ) M}{F} , … , M - 1.\end{matrix} \qquad ( 8 )$$

In pseudo code, this might appear as:

```
For i = 0,...,(M/F)−1:
  m(i) = rand(0 ,...,B−1);
  Reshape and load row m(i) of H_{N} onto the DMD or other
  modulating device;
  For k = 1,...,F−1:
    Reshape and load new portion of row m(i+kB) of H_{N} onto
    the appropriate DMD-blocks (or the appropriate blocks
    of other modulating device);
  End for
End for.
```

The random rows still represent completely new data, so we must “clean the slate” each time and load all of their N bits. As in Equation (4), each of these random rows will take 16T to load. But since there are now just M/F random rows, the time to fully load all of them will take

$${T}_{F , rand} = \frac{M}{F} \cdot 16 T . \qquad ( 9 )$$

Similar to Equation (5), each of the affine-harmonically related rows still differ by exactly N/2 elements. (See the parenthetical note in the first paragraph of the section “General Case: F DMD-Blocks”.) Thus, loading just N/2 bits of new data for each of the affine-harmonically related rows will still only take (16/2)T, if the “new” data lines up perfectly with exactly half of the 16 DMD-blocks. But now there are (M/F)(F−1) of these rows, which in total will take

$${T}_{F , harm} = \frac{M}{F} ( F - 1 ) \cdot \frac{16}{2} T \qquad ( 10 )$$

seconds to load. Adding Equations (9) and (10) and substituting Equation (1), the total time to load the M patterns will generally be

$${T}_{F} = {T}_{F , rand} + {T}_{F , harm} = \frac{{2}^{K} + 1}{{2}^{( K + 1 )}} \cdot {T}_{0} . \qquad ( 11 )$$

The best speed-up we can hope to achieve from this is

$${T}_{min} = {lim}_{K -> ∞} ( {T}_{F} ) = \frac{1}{2} \cdot {T}_{0} , \qquad ( 12 )$$

but there are theoretical and practical reasons not to use too large a value of K.

For example, to take advantage of the 16-block bus architecture of the XGA-DMD, we set K=4 in Equation (11), and therefore can realize a speed-up factor of 17/32, which is close to the ideal of ½ in Equation (12). (It may be possible to push beyond to affine-harmonic factors that are greater than F=16, but more analysis would be necessary since only portions of each of the 16 DMD-blocks would be updated for every affine-harmonically related row. We assumed above that one or more complete DMD-blocks were updated for every affine-harmonically related row.)

Note, before the rows of the Hadamard matrix are wrapped onto the DMD they are usually randomized in some manner (e.g., permuted, or multiplied with a random diagonal, etc.). Regardless of this operation, it will be the same for all of the rows/patterns. Thus the randomization step will be agnostic to the technique described here.

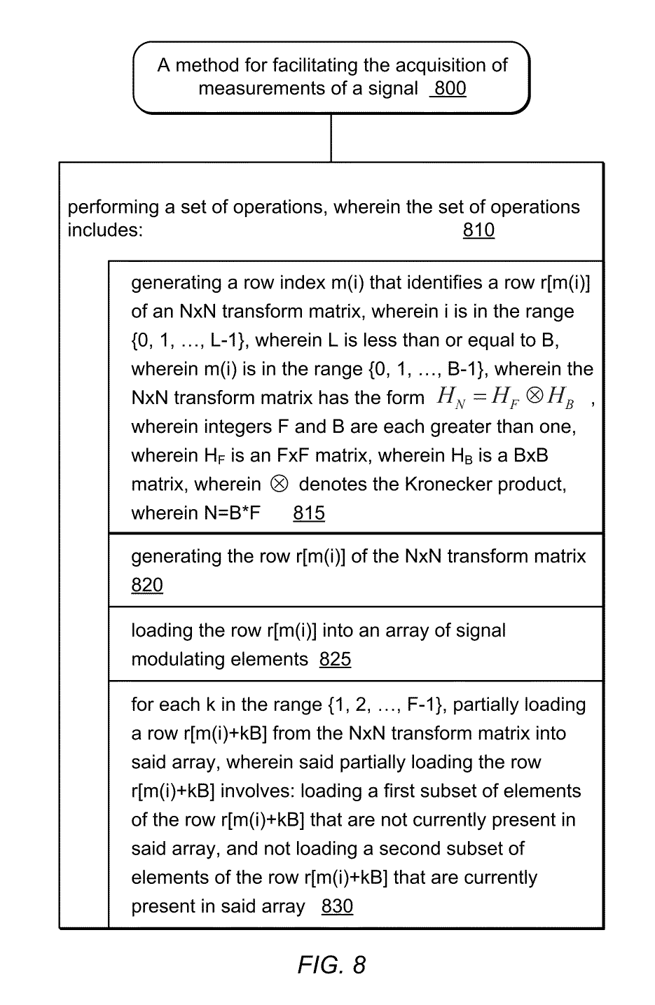

In one set of embodiments, a method 800 may involve the operations shown in FIG. 8. (The method 800 may also include any subset of the features, elements and embodiments described above.) The method 800 may be used to facilitate the acquisition of measurements of a signal. The signal may be an image carried in a light stream (e.g., as variously described above). However, a wide variety of other types of signal are contemplated.

The method 800 may include performing a set of operations, as indicated in FIG. 8 by label 810. The set of operations may include operations 815 through 830.

At 815, a row index m(i) is generated, where the row index m(i) identifies a row r[m(i)] of an N×N transform matrix. The index i may be in the range {0, 1, . . . , L−1}, where L is less than or equal to B. (In some embodiments, we identify the value L with the above-described value M/F.) The row index m(i) is in the range {0, 1, . . . , B−1}. (It is assumed here that the rows of the N×N transform matrix are numbered starting at zero. However, that choice is a matter of convenience. The range {0, 1, . . . , B−1} may be more generally interpreted as the range corresponding to the first B rows of the N×N transform matrix.) The N×N transform matrix has the form

H_{N}=H_{F} [symbol] H_{B},

where integers F and B are each greater than one, where H_{F} is an F×F matrix, where H_{B} is a B×B matrix, where [symbol] denotes the Kronecker product. Thus, it follows that N=B*F, by definition of the Kronecker product. For the definition of the Kronecker product, see, e.g., Wikipedia at http://en.wikipedia.org/wiki/Kronecker_product.

The row index m(i) may be generated randomly, e.g., using a pseudo-random number generator. Alternatively, the row index m(i) may be generated non-randomly.

At 820, the row r[m(i)] of the N×N transform matrix is generated, e.g., as variously described above.

At 825, the row r[m(i)] is loaded into an array of signal modulating elements, e.g., as variously described above.

It should be understood that the row-generating operation 820 and the row-loading operation 825 may be performed in parallel, or at least partially in parallel. For example, the operation 825 may load a given portion of the row r[m(i)] while operation 820 generates a next portion of the row.

In some embodiments, the array of signal modulating elements may be identified with the light modulation unit 110 as described above. For example, in one embodiment, the array of signal modulating elements is a digital micromirror device (DMD). However, the inventive principles described herein apply to any of a wide variety of types of signal and types of signal modulation.

For each k in the range {1, 2, . . . , F−1}, a row r[m(i)+kB] from the N×N transform matrix is partially loaded into the array, as indicated in FIG. 8 by label 830. (In an alternative embodiment, the index k runs through a proper subset of the range {1, 2, . . . , F−1}, e.g., a subset of the form {1, 2, . . . , n_{SS}}, where n_{SS} is less than F−1.) The action of partially loading the row r[m(i)+kB] involves: loading a first subset of elements of the row r[m(i)+kB] that are not currently present in said array, and not loading a second subset of elements of the row r[m(i)+kB] that are currently present in said array.

In some embodiments, the operation 820 of generating the row r[m(i)] of the N×N transform matrix includes: (a) generating an m(i)^{th} row of the matrix H_{B}; and (b) concatenating F scaled copies of the m(i)^{th} row, where each of the F scaled copies corresponds to a respective element from a particular row of the matrix H_{F}, where each of the F scaled copies equals the m(i)^{th} row times the respective element from the particular row of the matrix H_{F}.

In some embodiments, the row r[m(i)+kB] includes F contiguous portions that correspond respectively to the F elements in the k^{th} row of H_{F}. Each of the F contiguous portions corresponds to respective copy of H_{B} with the matrix-block [symbol] ₖ. Furthermore, each of the F contiguous portions belongs to either the first subset or the second subset of elements based on whether the respective element in the k^{th} row of H_{F} agrees with the respective element in a previously-used row of H_{F}. The previously-used row of H_{F} may, e.g., be the row that was used to generate row r[m(i)+(k−1)B] of H_{N}. Thus, the method may involve comparing H_{F}[k,j] to H_{F}[k−1,j] for each j =0, 1, . . . , F−1, where H_{F}[u,v] denotes the element of H_{F} resides in the u^{th} row and vₜₕ column of H_{F}:

```
For i = 0, 1, ..., L−1:
  Load row r[m(i)] of H_{N};
  For k = 1, 2, ..., F−1:
    For j = 0, 1, 2, ..., F−1:
      If H_{F}[k,j] ≠ HF[k−1,j]
      Then Load the j^{th} row portion of r[m(i)+kB];
    Endfor
  Endfor
Endfor
```

In some embodiments, the index j runs through the set {1, 2, . . . , F−1} instead of the set {0, 1, 2, . . . , F−1}.

In some embodiments, the set of operations is performed a plurality of times, e.g., L times.

In some embodiments, said signal modulating array is a digital micromirror device (DMD). The DMD modulates an incident light stream with a temporal sequence of spatial patterns to obtain a modulated light stream. Each of the spatial patterns of the temporal sequence is determined by a corresponding one of the rows {r[m(i)]} or a corresponding one of the rows {r[m(i)+kB]}. A light sensing device (e.g., the light sensing device 130) captures measurements of intensity of the modulated light stream over time. The measurements are usable to perform any of various detection and/or estimation processes on the scene under observation (i.e., the scene carried by the incident light stream). For example, the measurements may be used to detect an object of interest in the scene. As another example, the measurements may be used to computationally reconstruct an image representing a snapshot of the incident light stream, e.g., as variously described above.

In some embodiments, one or more of the operations 815 through 830 are performed by digital circuitry. The digital circuitry may include one or more of the following: (a) one or more programmable hardware elements; (b) one or more application specific integrated circuits (ASICs); (c) one or more processors configured to execute program instructions.

In some embodiments, the signal modulating array includes F non-overlapping rectangular subarrays. Each of the subarrays includes B of the signal modulating elements.

In some embodiments, the matrix H_{F} is a binary-valued matrix, and/or, the matrix H_{B} is a binary-valued matrix. A matrix is said to be binary valued when it elements are drawn from a set consisting of two elements.

In some embodiments, the matrix H_{F} is a Hadamard matrix and/or the matrix H_{B} is a Hadamard matrix.

In some embodiments, F is a positive integer power of two.

In some embodiments, B is a power of two. In other embodiments, B is not a power of two.

Various additional embodiments are disclosed in the following numbered paragraphs.

1. A non-transitory memory medium storing program instructions, wherein the program instructions, when executed by a computer system, cause the computer system to implement:

performing a set of operations, wherein the set of operations includes:

(a) generating a row index m(i) that identifies a row r[m(i)] of an N×N transform matrix, wherein i is in the range {0, 1, . . . , L−1}, wherein L is less than or equal to B, wherein m(i) is in the range {0, 1, . . . , B−1}, wherein the N×N transform matrix has the form H_{N}=H_{F} [symbol] H_{B}, wherein integers F and B are each greater than one, wherein H_{F} is an F×F matrix, wherein H_{B} is a B×B matrix, wherein N=B*F, wherein [symbol] denotes the Kronecker product;

(b) generating the row r[m(i)] of the N×N transform matrix;

(c) loading the row r[m(i)] into an array of signal modulating elements;

(d) for each k in the range {1, 2, . . . , F−1}, partially loading a row r[m(i)+kB] from the N×N transform matrix into said array, wherein said partially loading the row r[m(i)+kB] involves: loading a first subset of elements of the row r[m(i)+kB] that are not currently present in said array, and not loading a second subset of elements of the row r[m(i)+kB] that are currently present in said array.

2. The memory medium of paragraph 1, wherein said generating the row r[m(i)] of the N×N transform matrix includes: generating an m(i)^{th} row of the matrix H_{B}; and concatenating F scaled copies of the m(i)^{th} row, wherein each of the F scaled copies corresponds to a respective element from a particular row of the matrix H_{F}, wherein each of the F scaled copies equals the m(i)^{th} row times the respective element from the particular row of the matrix H_{F}.

3. The memory medium of paragraph 1, wherein the row r[m(i)+kB] includes F contiguous portions that correspond respectively to the F elements in the k^{th} row of H_{F}, where each of the F contiguous portions belongs to either the first subset or the second subset of elements based on whether the respective element in the k^{th} row of H_{F} agrees with the respective element in a previously-used row of H_{F}.

4. The memory medium of paragraph 1, wherein said array is a digital micromirror device (DMD).

5. The memory medium of paragraph 1, wherein the array includes F non-overlapping rectangular subarrays, wherein each of the subarrays includes B of the signal modulating elements.

6. A system for facilitating the acquisition of measurements of a signal, the system comprising: digital circuitry configured to perform a set of operations, wherein the set of operations includes:

(a) generating a row index m(i) that identifies a row r[m(i)] of an N×N transform matrix, wherein i is in the range {0, 1, . . . , L−1}, wherein L is less than or equal to B, wherein m(i) is in the range {0, 1, . . . , B−1}, wherein the N×N transform matrix has the form H_{N}=H_{F} [symbol] H_{B}, wherein integers F and B are each greater than one, wherein H_{F} is an F×F matrix, wherein H_{B} is a B×B matrix, wherein N=B*F, wherein [symbol] denotes the Kronecker product; (b) generating the row r[m(i)] of the N×N transform matrix;

(c) loading the row r[m(i)] into an array of signal modulating elements; (d) for each k in the range {1, 2, . . . , F−1}, partially loading a row r[m(i)+kB] from the N×N transform matrix into said array, wherein said partially loading the row r[m(i)+kB] involves: loading a first subset of elements of the row r[m(i)+kB] that are not currently present in said array, and not loading a second subset of elements of the row r[m(i)+kB] that are currently present in said array.

7. The system of paragraph 6, wherein said generating the row r[m(i)] of the N×N transform matrix includes: generating an m(i)^{th} row of the matrix H_{B}; and concatenating F scaled copies of the m(i)^{th} row, wherein each of the F scaled copies corresponds to a respective element from a particular row of the matrix H_{F}, wherein each of the F scaled copies equals the m(i)^{th} row times the respective element from the particular row of the matrix H_{F}.

8. The system of paragraph 6, wherein the row r[m(i)+kB] includes F contiguous portions that correspond respectively to the F elements in the k^{th} row of H_{F}, where each of the F contiguous portions belongs to either the first subset or the second subset of elements based on whether the respective element in the k^{th} row of H_{F} agrees with the respective element in a previously-used row of H_{F}.

9. The system of paragraph 6, wherein the digital circuitry includes one or more of the following: one or more programmable hardware elements; one or more application specific integrated circuits (ASICs); one or more processors configured to execute program instructions.

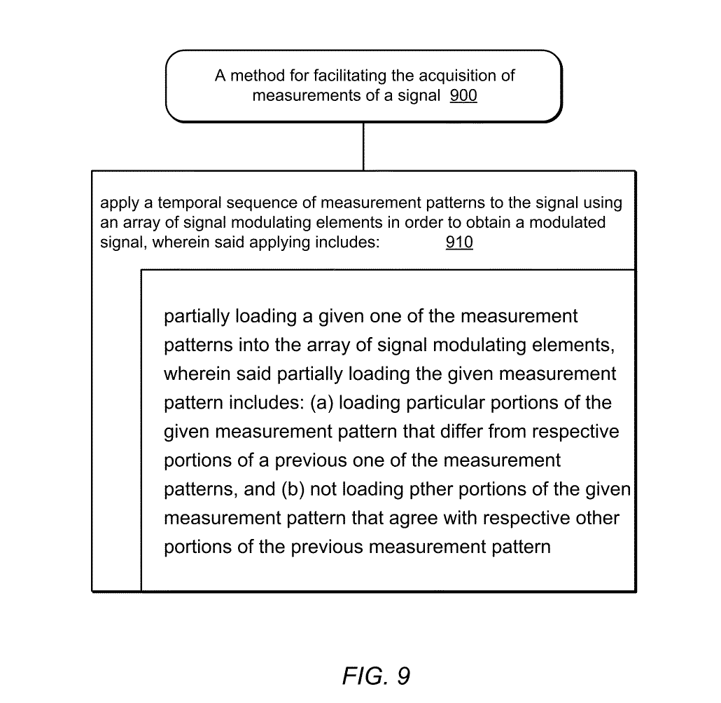

In one set of embodiments, a method 900 may involve the operations shown in FIG. 9. (The method 900 may also include any subset of the features, elements and embodiments described above.) Method 900 may be used to facilitate the acquisition of measurements of a signal.

At 910, a temporal sequence of measurement patterns is applied to the signal using an array of signal modulating elements, in order to obtain a modulated signal, e.g., as variously described above. The action of applying the temporal sequence of measurment patterns may include partially loading a given one of the measurement patterns into the array of signal modulating elements. The action of partially loading the given measurement pattern includes: (a) loading particular portions of the given measurement pattern that differ from respective portions of a previous one of the measurement patterns, and (b) not loading other portions of the given measurement pattern that agree with respective other portions of the previous measurement pattern. The action of partially loading the given measurement pattern may be performed by digital circuitry, e.g., as variously described above. The given measurement pattern may be a pattern that immediately follows the previous measurement pattern in the temporal sequence. Prior to said partially loading the given measurement pattern, the previous measurement pattern may already be resident in the signal modulation array.

In some embodiments, the method 900 also includes acquiring measurements of intensity of the modulated signal using a sensing device, e.g., as variously described above. Each of the measurements corresponds to a respective one of the measurement patterns.

In some embodiments, the signal is a stream of light, wherein the signal modulating elements are light modulating elements included in a light modulation unit, wherein each of the measurement patterns specifies a modulation value for each of the light modulating elements.

In some embodiments, the measurement patterns are defined by respective rows in a matrix having a Kronecker-product structure.

In some embodiments, the digital circuitry includes one or more of the following: (a) one or more programmable hardware elements; (b) one or more application specific integrated circuits (ASICs); and (c) one or more processors configured to execute program instructions.

In one set of embodiments, a system may include an array of signal modulating elements and digital circuitry. (The system may also include any subset of the features, elements, and embodiments described above.) The digital circuitry may be configured to provide a temporal sequence of measurement patterns to the array of signal modulating elements. The array of signal modulating elements is configured to modulate a signal with the temporal sequence of measurement patterns in order to obtain a modulated signal.

The action of providing the temporal sequence of measurement patterns to the array may include: partially loading a given one of the measurement patterns into the array of signal modulating elements, wherein said partially loading the given measurement pattern includes: (a) loading first portions of the given measurement pattern that differ from respective first portions of a previous one of measurement patterns, and (b) not loading second portions of the given measurement pattern that agree with respective second portions of the previous measurement pattern, wherein said partially loading is performed by digital circuitry.

In some embodiments, the system also includes a signal sensing device (e.g., as variously described above) configured to acquire measurements of intensity of the modulated signal using a sensing device, wherein each of the measurements corresponds to a respective one of the measurement patterns.

In some embodiments, the signal is a stream of light, wherein the signal modulating elements are light modulating elements included in a light modulation unit (e.g., as variously described above), wherein each of the measurement patterns specifies a modulation value for each of the light modulating elements.

In some embodiments, the measurement patterns correspond to respective rows in a matrix having a Kronecker-product structure.

In some embodiments, the digital circuitry includes one or more of the following: (a) one or more programmable hardware elements; (b) one or more application specific integrated circuits (ASICs); (c) one or more processors configured to execute program instructions.

In some embodiments, each of the measurement patterns corresponds to a respective row of an N×N transform matrix, wherein the N×N transform matrix has the form H_{N}=H_{F} [symbol] H_{B}, wherein integers F and B are each greater than one, wherein H_{F} is an F×F matrix, wherein H_{B} is a B×B matrix, wherein N=B*F, wherein [symbol] denotes the Kronecker product, wherein the previous measurement pattern corresponds to a row r[x] of the N×N transform matrix at row index x, wherein the given measurement pattern corresponds to a row r[x+kB] of the N×N transformation matrix at row index x+kB, wherein k is a nonzero integer, wherein said partially loading the given measurement pattern includes: loading a first subset of elements of the row r[x+kB] that are not currently present in said array, and not loading a second subset of elements of the row r[x+kB] that are currently present in said array. Both x and x+kB are in the range {0, 1, 2, . . . , N−1} i.e., the range of the row indices of the matrix H_{N}.

Any of the various embodiments described herein may be realized in any of various forms, e.g., as a computer-implemented method, as a computer-readable memory medium, as a computer system. A system may be realized by one or more custom-designed hardware devices such as ASICs, by one or more programmable hardware elements such as FPGAs, by one or more processors executing stored program instructions, or by any combination of the foregoing.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a mobile device, a wearable computer, a sensing device, an image acquisition device, a video acquisition device, a computer embedded in a living organism, etc.

Any of the various embodiments described herein may be combined to form composite embodiments. Furthermore, any of the various features, embodiments and elements described in U.S. Provisional Application No. 61/759,003 may be combined with any of the various embodiments described herein.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
applying a temporal sequence of measurement patterns to a signal using an array of signal modulating elements in order to obtain a modulated signal, wherein said applying includes:
partially loading a given one of the measurement patterns into the array of signal modulating elements, wherein said partially loading the given measurement pattern includes: (a) loading first portions of the given measurement pattern that differ from respective first portions of a previous one of measurement patterns, and (b) not loading second portions of the given measurement pattern that agree with respective second portions of the previous measurement pattern, wherein said partially loading is performed by digital circuitry.

2. The method of claim 1, further comprising:
acquiring measurements of intensity of the modulated signal using a sensing device, wherein each of the measurements corresponds to a respective one of the measurement patterns.

3. The method of claim 1, wherein the signal is a stream of light, wherein the signal modulating elements are light modulating elements included in a light modulation unit, wherein each of the measurement patterns specifies a modulation value for each of the light modulating elements.

4. The method of claim 1, wherein the measurement patterns correspond to respective rows in a matrix having a Kronecker-product structure.

5. The method of claim 1, wherein the digital circuitry includes one or more of the following:
one or more programmable hardware elements;
one or more application specific integrated circuits (ASICs);
one or more processors configured to execute program instructions.

6. A system comprising:
an array of signal modulating elements; and
digital circuitry configured to provide a temporal sequence of measurement patterns to the array of signal modulating elements, wherein the array of signal modulating elements is configured to modulate a signal with the temporal sequence of measurement patterns in order to obtain a modulated signal, wherein said providing the temporal sequence of measurement patterns to the array includes:
partially loading a given one of the measurement patterns into the array of signal modulating elements, wherein said partially loading the given measurement pattern includes: (a) loading first portions of the given measurement pattern that differ from respective first portions of a previous one of measurement patterns, and (b) not loading second portions of the given measurement pattern that agree with respective second portions of the previous measurement pattern, wherein said partially loading is performed by digital circuitry.

7. The system of claim 6, further comprising:
a signal sensing device configured to acquire measurements of intensity of the modulated signal using a sensing device, wherein each of the measurements corresponds to a respective one of the measurement patterns.

8. The system of claim 6, wherein the signal is a stream of light, wherein the signal modulating elements are light modulating elements included in a light modulation unit, wherein each of the measurement patterns specifies a modulation value for each of the light modulating elements.

9. The system of claim 6, wherein the measurement patterns correspond to respective rows in a matrix having a Kronecker-product structure.

10. The system of claim 6, wherein the digital circuitry includes one or more of the following:
one or more programmable hardware elements;
one or more application specific integrated circuits (ASICs);
one or more processors configured to execute program instructions.

11. The system of claim 6, wherein each of the measurement patterns corresponds to a respective row of an N×N transform matrix, wherein the N×N transform matrix has the form
H_{N}=H_{F} [symbol] H_{B},
wherein integers F and B are each greater than one, wherein H_{F} is an F×F matrix, wherein H_{B} is a B×B matrix, wherein N=B*F, wherein [symbol] denotes the Kronecker product, wherein the previous measurement pattern corresponds to a row r[x] of the N×N transform matrix at row index x, wherein the given measurement pattern corresponds to a row r[x+kB] of the N×N transformation matrix at row index x+kB, wherein k is a nonzero integer, wherein said partially loading the given measurement pattern includes: loading a first subset of elements of the row r[x+kB] that are not currently present in said array, and not loading a second subset of elements of the row r[x+kB] that are currently present in said array.

12. A method for facilitating the acquisition of measurements of a signal, the method comprising:
performing a set of operations, wherein the set of operations includes:
(a) generating a row index m(i) that identifies a row r[m(i)] of an N×N transform matrix, wherein i is in the range {0, 1, . . . , L−1}, wherein L is less than or equal to B, wherein m(i) is in the range {0, 1, . . . , B−1}, wherein the N×N transform matrix has the form
H_{N}=H_{F} [symbol] H_{B},
wherein integers F and B are each greater than one, wherein H_{F} is an F×F matrix, wherein H_{B} is a B×B matrix, wherein N=B*F, wherein [symbol] denotes the Kronecker product;
(b) generating the row r[m(i)] of the N×N transform matrix;
(c) loading the row r[m(i)] into an array of signal modulating elements;
(d) for each k in the range {1, 2, . . . , F−1}, partially loading a row r[m(i)+kB] from the N×N transform matrix into said array, wherein said partially loading the row r[m(i)+kB] involves: loading a first subset of elements of the row r[m(i)+kB] that are not currently present in said array, and not loading a second subset of elements of the row r[m(i)+kB] that are currently present in said array.

13. The method of claim 12, wherein said generating the row r[m(i)] of the N×N transform matrix includes:
generating an m(i)^{th} row of the matrix H_{B}; and
concatenating F scaled copies of the m(i)^{th} row, wherein each of the F scaled copies corresponds to a respective element from a particular row of the matrix H_{F}, wherein each of the F scaled copies equals the m(i)^{th} row times the respective element from the particular row of the matrix H_{F}.

14. The method of claim 12, wherein the row r[m(i)+kB] includes F contiguous portions that correspond respectively to the F elements in the k^{th} row of H_{F}, where each of the F contiguous portions belongs to either the first subset or the second subset of elements based on whether the respective element in the k^{th} row of H_{F} agrees with the respective element in a previously-used row of H_{F}.

15. The method of claim 12, where the set of operations is performed a plurality of times.

16. The method of claim 15, wherein said array is a digital micromirror device (DMD), wherein the DMD modulates an incident light stream with a temporal sequence of spatial patterns to obtain a modulated light stream, wherein each of the spatial patterns of the temporal sequence is determined by a corresponding one of the rows {r[m(i)]} or a corresponding one of the rows {r[m(i)+kB]}, wherein a light sensing device captures measurements of intensity of the modulated light stream over time.

17. The method of claim 12, wherein one or more of (a), (b), (c) and (d) are performed by digital circuitry.

18. The method of claim 12, wherein the digital circuitry includes one or more of the following:
one or more programmable hardware elements;
one or more application specific integrated circuits (ASICs);
one or more processors configured to execute program instructions.

19. The method of claim 12, wherein the array includes F non-overlapping rectangular subarrays, wherein each of the subarrays includes B of the signal modulating elements.

20. The method of claim 12, wherein the matrix H_{F} is a binary-valued matrix, and/or, the matrix H_{B} is a binary-valued matrix.
